(19) United States
(12) Patent Application Publication
(10) Pub. No.: US 2026/0039642 A1
(43) Pub. Date: Feb. 5, 2026

(54) MULTI-APPLICATION SINGLE-SIGN ON VIA DEVICE SESSION ESTABLISHMENT

(71) Applicant: OKTA, INC., SAN FRANCISCO, CA (US)

(72) Inventors: Stephen Woodward LIND, El Cerrito, CA (US); Vadim DMITRIEV, Mountain View, CA (US); Peter MILLER, Morgan Hill, CA (US); Michael Scott BIVIANO, Saint Louis, MO (US); Desmond Dik Ming WONG, Thornhill (CA); Umang SHAH, Fremont, CA (US)

(21) Appl. No.: 18/791,121

(22) Filed: Jul. 31, 2024

(51) Int. Cl. H04L 9/40; H04L 65/1069

(52) U.S. Cl. CPC H04L 63/0807; H04L 65/1069

(57) ABSTRACT

A user device including an authenticator application may transmit signaling to an authorization server for a first authorization procedure to establish a first session between the user device and a first server of a first organization. The user device may transmit, to the authorization server, a request to access a different resource after establishing the first session. The user device may receive, by the authenticator application, an authentication challenge from the authorization server and transmit a response to the authentication challenge including a token indicative of the first session established via the first authorization procedure. The user device may establish a second session between the user device and a second server based on transmitting the response to the authentication challenge, where the second session is associated with the first session in accordance with the response to the authentication challenge including the token.

### FIELD OF TECHNOLOGY

The present disclosure relates generally to identity management, and more specifically to multi-application single sign-on (SSO) via device session establishment.

### BACKGROUND

An identity management system may be employed to manage and store various forms of user data, including usernames, passwords, email addresses, permissions, roles, group memberships, etc. The identity management system may provide authentication services for applications, devices, users, and the like. The identity management system may enable organizations to manage and control access to resources, for example, by serving as a central repository that integrates with various identity sources. The identity management system may provide an interface that enables users to access a multitude of applications with a single set of credentials. In some cases, a user may establish a session with a server based on or after performing an authentication procedure. The user may access the session after session establishment using an access token associated with the session.

### SUMMARY

A method for establishing sessions via an authorization server by an apparatus is described. The method may include transmitting signaling to the authorization server for a first authorization procedure to establish a first session between a user device and a first server of a first organization, transmitting, to the authorization server, a request to access a resource after establishing the first session, receiving, by an authenticator application of the user device, an authentication challenge from the authorization server, transmitting, to the authorization server, a response to the authentication challenge including a token indicative of the first session established via the first authorization procedure, and establishing a second session between the user device and a second server based on transmitting the response to the authentication challenge, where the second session is associated with the first session in accordance with the response to the authentication challenge including the token.

An apparatus for establishing sessions via an authorization server is described. The apparatus may include one or more memories storing processor executable code, and one or more processors coupled with the one or more memories. The one or more processors may individually or collectively be operable to execute the code to cause the apparatus to transmit signaling to the authorization server for a first authorization procedure to establish a first session between a user device and a first server of a first organization, transmit, to the authorization server, a request to access a resource after establishing the first session, receive, by an authenticator application of the user device, an authentication challenge from the authorization server, transmit, to the authorization server, a response to the authentication challenge including a token indicative of the first session established via the first authorization procedure, and establish a second session between the user device and a second server based on transmitting the response to the authentication challenge, where the second session is associated with the first session in accordance with the response to the authentication challenge including the token.

Another apparatus for establishing sessions via an authorization server is described. The apparatus may include means for transmitting signaling to the authorization server for a first authorization procedure to establish a first session between a user device and a first server of a first organization, means for transmitting, to the authorization server, a request to access a resource after establishing the first session, means for receiving, by an authenticator application of the user device, an authentication challenge from the authorization server, means for transmitting, to the authorization server, a response to the authentication challenge including a token indicative of the first session established via the first authorization procedure, and means for establishing a second session between the user device and a second server based on transmitting the response to the authentication challenge, where the second session is associated with the first session in accordance with the response to the authentication challenge including the token.

A non-transitory computer-readable medium storing code for establishing sessions via an authorization server is described. The code may include instructions executable by one or more processors to transmit signaling to the authorization server for a first authorization procedure to establish a first session between a user device and a first server of a first organization, transmit, to the authorization server, a request to access a resource after establishing the first session, receive, by an authenticator application of the user device, an authentication challenge from the authorization server, transmit, to the authorization server, a response to the authentication challenge including a token indicative of the first session established via the first authorization procedure, and establish a second session between the user device and a second server based on transmitting the response to the authentication challenge, where the second session is associated with the first session in accordance with the response to the authentication challenge including the token.

In some examples of the method, apparatus, and non-transitory computer-readable medium described herein, establishing the second session based on transmitting the response including the token may include operations, features, means, or instructions for establishing the second session between the user device and the second server based on transmitting the response including the token and based on the first session associated with the token satisfying an assurance level associated with access to the second server.

Some examples of the method, apparatus, and non-transitory computer-readable medium described herein may further include operations, features, means, or instructions for transmitting second signaling to the authorization server for a second authorization procedure to establish the second session between the user device and the second server, where transmitting the second signaling may be based on the first session associated with the token failing to satisfy an assurance level associated with access to the second server and establishing the second session between the user device and the second server based on transmitting the response to the authentication challenge including the token and the second authorization procedure, where a combination of the first authorization procedure associated with the first session and the second authorization procedure associated with the second session satisfy the assurance level.

Some examples of the method, apparatus, and non-transitory computer-readable medium described herein may further include operations, features, means, or instructions for establishing the second session may be based on the first session satisfying a policy associated with the second server, the policy indicating a time duration for which the token associated with the first session may be usable to establish sessions with the second server.

In some examples of the method, apparatus, and non-transitory computer-readable medium described herein, the first authorization procedure includes a multi-factor authentication (MFA) procedure and the method, apparatuses, and non-transitory computer-readable medium may include further operations, features, means, or instructions for prompting, via a user interface of the authenticator application, a user of the user device to input information associated with at least two factors of a set of multiple factors of the MFA procedure and receiving, after prompting the user to input the information, one or more user inputs indicative of the at least two factors, where transmitting the signaling to the authorization server may be based on receiving the one or more user inputs.

In some examples of the method, apparatus, and non-transitory computer-readable medium described herein, the set of multiple factors include a password, one or more security questions, Short Message Service (SMS) verification, voice verification, email verification, push verification via the authenticator application, possession of a cryptographic key, or any combination thereof.

Some examples of the method, apparatus, and non-transitory computer-readable medium described herein may further include operations, features, means, or instructions for receiving the authentication challenge from the authorization server by the authenticator application includes intercepting the authentication challenge transmitted from the authorization server to the user device.

In some examples of the method, apparatus, and non-transitory computer-readable medium described herein, transmitting the signaling to the authorization server may include operations, features, means, or instructions for transmitting the signaling to the authorization server during or after a user login to the user device.

In some examples of the method, apparatus, and non-transitory computer-readable medium described herein, the response to the authentication challenge further includes an origin of the request, information associated with a security posture of the user device, a first attestation signed via a device-bound key, a second attestation signed via a user-bound key, or any combination thereof.

In some examples of the method, apparatus, and non-transitory computer-readable medium described herein, the authenticator application may be registered with the authorization server via a hardware-backed private key.

In some examples of the method, apparatus, and non-transitory computer-readable medium described herein, the user device may be associated with a user having a second private key.

In some examples of the method, apparatus, and non-transitory computer-readable medium described herein, the first authorization procedure may be in accordance with a MFA policy, a device posture policy, or both associated with the user device, the first organization, or both.

A method for establishing sessions via an authorization server by an apparatus is described. The method may include performing, via the authorization server, a first authorization procedure to establish a first session between a user device and a first server of a first organization, receiving, from the user device, a request to access a resource after establishing the first session, transmitting, to the user device, an authentication challenge in response to the request, receiving, from an authenticator application of the user device, a response to the authentication challenge including a token indicative of the first session established via the first authorization procedure, and establishing a second session between the user device and a second server based on receiving the response to the authentication challenge, where the second session is associated with the first session in accordance with the response to the authentication challenge including the token.

An apparatus for establishing sessions via an authorization server is described. The apparatus may include one or more memories storing processor executable code, and one or more processors coupled with the one or more memories. The one or more processors may individually or collectively be operable to execute the code to cause the apparatus to perform, via the authorization server, a first authorization procedure to establish a first session between a user device and a first server of a first organization, receive, from the user device, a request to access a resource after establishing the first session, transmit, to the user device, an authentication challenge in response to the request, receive, from an authenticator application of the user device, a response to the authentication challenge including a token indicative of the first session established via the first authorization procedure, and establish a second session between the user device and a second server based on receiving the response to the authentication challenge, where the second session is associated with the first session in accordance with the response to the authentication challenge including the token.

Another apparatus for establishing sessions via an authorization server is described. The apparatus may include means for performing, via the authorization server, a first authorization procedure to establish a first session between a user device and a first server of a first organization, means for receiving, from the user device, a request to access a resource after establishing the first session, means for transmitting, to the user device, an authentication challenge in response to the request, means for receiving, from an authenticator application of the user device, a response to the authentication challenge including a token indicative of the first session established via the first authorization procedure, and means for establishing a second session between the user device and a second server based on receiving the response to the authentication challenge, where the second session is associated with the first session in accordance with the response to the authentication challenge including the token.

A non-transitory computer-readable medium storing code for establishing sessions via an authorization server is described. The code may include instructions executable by one or more processors to perform, via the authorization server, a first authorization procedure to establish a first session between a user device and a first server of a first organization, receive, from the user device, a request to access a resource after establishing the first session, transmit, to the user device, an authentication challenge in response to the request, receive, from an authenticator application of the user device, a response to the authentication challenge including a token indicative of the first session established via the first authorization procedure, and establish a second session between the user device and a second server based on receiving the response to the authentication challenge, where the second session is associated with the first session in accordance with the response to the authentication challenge including the token.

Some examples of the method, apparatus, and non-transitory computer-readable medium described herein may further include operations, features, means, or instructions for determining that the first session associated with the token satisfies an assurance level associated with access to the second server, where establishing the second session based on receiving the response including the token further includes and establishing the second session between the user device and the second server based on determining that the first session associated with the token satisfies the assurance level.

Some examples of the method, apparatus, and non-transitory computer-readable medium described herein may further include operations, features, means, or instructions for determining that the first session associated with the token fails to satisfy an assurance level associated with access to the second server, performing, via the authorization server, a second authorization procedure to establish the second session between the user device and the second server based on determining that the first session associated with the token fails to satisfy the assurance level, where establishing the second session based on receiving the response including the token further includes, and establishing the second session between the user device and the second server based on receiving the response to the authentication challenge including the token and performing the second authorization procedure, where a combination of the first authorization procedure associated with the first session and the second authorization procedure associated with the second session satisfy the assurance level.

Some examples of the method, apparatus, and non-transitory computer-readable medium described herein may further include operations, features, means, or instructions for establishing the second session may be based on the first session satisfying a policy associated with the second server, the policy indicating a time duration for which the token associated with the first session may be usable to establish sessions with the second server.

In some examples of the method, apparatus, and non-transitory computer-readable medium described herein, the first authorization procedure includes a MFA procedure and the method, apparatuses, and non-transitory computer-readable medium may include further operations, features, means, or instructions for receiving information indicative of at least two factors of a set of multiple factors of the MFA procedure, where performing the first authorization procedure includes verifying the at least two factors.

In some examples of the method, apparatus, and non-transitory computer-readable medium described herein, the set of multiple factors include a password, one or more security questions, Short Message Service (SMS) verification, voice verification, email verification, push verification via the authenticator application, possession of a cryptographic key, or any combination thereof.

In some examples of the method, apparatus, and non-transitory computer-readable medium described herein, performing the first authorization procedure may include operations, features, means, or instructions for performing the first authorization procedure during or after a user login to the user device.

In some examples of the method, apparatus, and non-transitory computer-readable medium described herein, the response to the authentication challenge further includes an origin of the request, information associated with a security posture of the user device, a first attestation signed via a device-bound key, a second attestation signed via a user-bound key, or any combination thereof.

In some examples of the method, apparatus, and non-transitory computer-readable medium described herein, the authenticator application may be registered with the authorization server via a hardware-backed private key.

In some examples of the method, apparatus, and non-transitory computer-readable medium described herein, the user device may be associated with a user having a second private key.

In some examples of the method, apparatus, and non-transitory computer-readable medium described herein, the first authorization procedure may be in accordance with a MFA policy, a device posture policy, or both associated with the user device, the first organization, or both.

### BRIEF DESCRIPTION OF THE DRAWINGS

FIGS. 1 and 2 show examples of computing systems that support multi-application single sign-on (SSO) via device session establishment in accordance with aspects of the present disclosure.

FIGS. 3 and 4 show examples of process flows that support multi-application SSO via device session establishment in accordance with aspects of the present disclosure.

FIG. 5 shows a block diagram of an apparatus that supports multi-application SSO via device session establishment in accordance with aspects of the present disclosure.

FIG. 6 shows a block diagram of a device-bound session token manager that supports multi-application SSO via device session establishment in accordance with aspects of the present disclosure.

FIG. 7 shows a diagram of a system including a device that supports multi-application SSO via device session establishment in accordance with aspects of the present disclosure.

FIG. 8 shows a block diagram of an apparatus that supports multi-application SSO via device session establishment in accordance with aspects of the present disclosure.

FIG. 9 shows a block diagram of a device-bound session token manager that supports multi-application SSO via device session establishment in accordance with aspects of the present disclosure.

FIG. 10 shows a diagram of a system including a device that supports multi-application SSO via device session establishment in accordance with aspects of the present disclosure.

FIGS. 11 through 14 show flowcharts illustrating methods that support multi-application SSO via device session establishment in accordance with aspects of the present disclosure.

### DETAILED DESCRIPTION

A user may complete an authorization procedure (e.g., on a user device) to access an application or a resource of an organization. For example, the user may complete multi-factor authentication (MFA) and may satisfy one or more security constraints, such as device posture constraints (e.g., whether the device has a password, network location, device location, antivirus protection, etc.). In some cases, the user may complete identity assurance and consent to sign in, such as via inputting a personal identification number (PIN), providing biometrics, or the like. An authorization application on the user device may support at least a portion of the authorization procedure. For example, the authorization application may prompt the user to provide inputs to complete MFA, identity assurance and consent, or both. The authorization application may send the inputs provided by the user for the authorization procedure to an authorization server, where the authorization server enforces access policies to the organization.

After completing the authorization procedure, the user may receive an access token for one or more resources of (e.g., within, associated with, etc.) the organization. However, the access token may not be used to access other applications or organizations on the user device. That is, if the user attempts to access a different application or resource of another organization on the user device, the user may complete another authorization procedure, which may involve providing the same user inputs (e.g., for MFA, identity assurance, etc.) as the previously completed authorization procedure. In other words, because access tokens are not accessible to different applications (e.g., requiring another authorization procedure on the same device) of the organization or different organizations, the user may be required to complete additional authorization procedures for each additional application, organization, or both accessed via the user device. In some cases, organizations may configure access tokens to not expire for relatively long periods of time in order to avoid user fatigue associated with performing multiple authorization procedures. However, such tokens may be associated with reduced security levels, as a token may be obtained and used by an attacker for the duration of the life of the token (e.g., until a new token is provisioned). In other words, the token may be stolen and then used at a later date (e.g., within the life of the token) by unauthorized parties.

As described herein, the user device may access a resource of an organization based on a previously performed authorization procedure for a different resource. For example, after performing a first authorization procedure to establish a first session at the user device (e.g., after login to the user device, when no other sessions are established), the authorization server may store a record of one or more parameters associated with the first session. The one or more parameters may include a level of assurance, types of factors provided, properties of the first authorization procedure, a timestamp of when the first session is established, or the like.

When the user attempts to access a different resource (e.g., associated with a different access token), the authorization server may issue an authentication challenge. The authenticator application at the user device may obtain (e.g., intercept) the challenge and transmit a response to the authorization server including at least a token associated with the first session. That is, the authenticator application may respond to the authentication challenge without user input. The authorization server may determine whether the first session satisfies an assurance level associated with the different resource and either link a second session with the different resource to the first session (e.g., based on the assurance level being satisfied) or perform a second authorization procedure (e.g., based on the assurance level not being satisfied). By linking new sessions to an existing session without user input (e.g., or with reduced user input, in the case that a second authorization procedure is performed), techniques described herein may support improved user experience related to signing on to multiple applications on a user device.

Aspects of the disclosure are initially described in the context of computing systems. Aspects of the disclosure are also described in the context of process flows. Aspects of the disclosure are further illustrated by and described with reference to apparatus diagrams, system diagrams, and flowcharts that relate to multi-application single sign-on (SSO) via device session establishment.

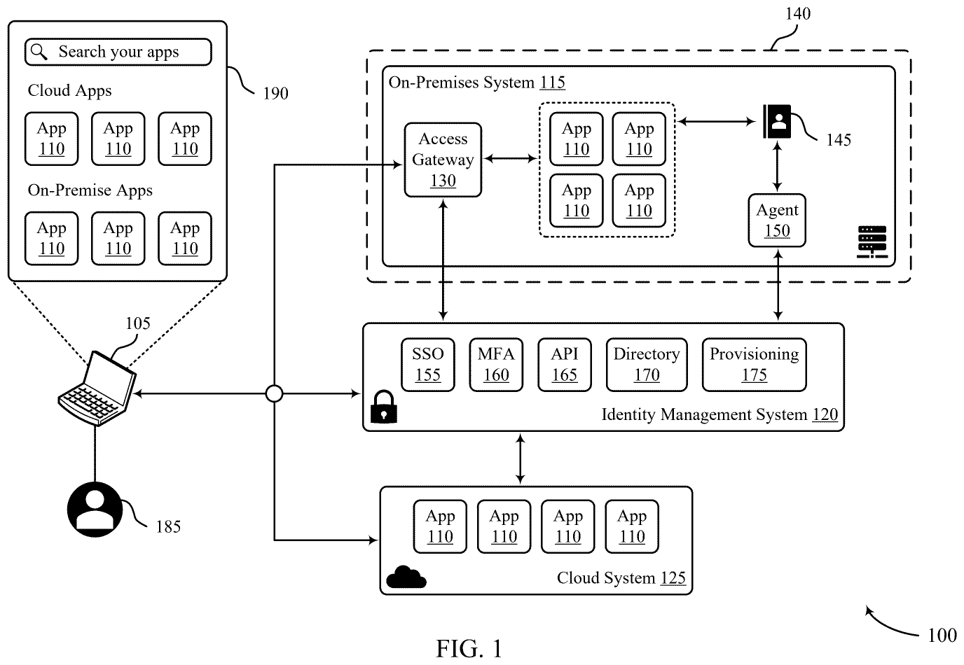

FIG. 1 illustrates an example of a computing system 100 that supports multi-application single sign on via device session establishment in accordance with various aspects of the present disclosure. The computing system 100 includes a computing device 105 (such as a desktop, laptop, smartphone, tablet, or the like), an on-premises system 115, an identity management system 120, and a cloud system 125, which may communicate with each other via a network, such as a wired network (e.g., the Internet), a wireless network (e.g., a cellular network, a wireless local area network (WLAN)), or both. In some cases, the network may be implemented as a public network, a private network, a secured network, an unsecured network, or any combination thereof. The network may include various communication links, hubs, bridges, routers, switches, ports, or other physical and/or logical network components, which may be distributed across the computing system 100.

The on-premises system 115 (also referred to as an on-premises infrastructure or environment) may be an example of a computing system in which a client organization owns, operates, and maintains its own physical hardware and/or software resources within its own data center(s) and facilities, instead of using cloud-based (e.g., off-site) resources. Thus, in the on-premises system 115, hardware, servers, networking equipment, and other infrastructure components may be physically located within the “premises” of the client organization, which may be protected by a firewall 140 (e.g., a network security device or software application that is configured to monitor, filter, and control incoming/outgoing network traffic). In some examples, users may remotely access or otherwise utilize compute resources of the on-premises system 115, for example, via a virtual private network (VPN).

In contrast, the cloud system 125 (also referred to as a cloud-based infrastructure or environment) may be an example of a system of compute resources (such as servers, databases, virtual machines, containers, and the like) that are hosted and managed by a third-party cloud service provider using third-party data center(s), which can be physically co-located or distributed across multiple geographic regions. The cloud system 125 may offer high scalability and a wide range of managed services, including (but not limited to) database management, analytics, machine learning (ML), artificial intelligence (AI), etc. Examples of cloud systems 125 include (AMAZON WEB SERVICES) AWS®, MICROSOFT AZURE®, GOOGLE CLOUD PLATFORM®, ALIBABA CLOUD®, ORACLE® CLOUD INFRASTRUCTURE (OCI), and the like.

The identity management system 120 may support one or more services, such as an SSO service 155, an MFA service 160, an application programming interface (API) service 165, a directory management service 170, or a provisioning service 175 for various on-premises applications 110 (e.g., applications 110 running on compute resources of the on-premises system 115) and/or cloud applications 110 (e.g., applications 110 running on compute resources of the cloud system 125), among other examples of services. The SSO service 155, the MFA service 160, the API service 165, the directory management service 170, and/or the provisioning service 175 may be individually or collectively provided (e.g., hosted) by one or more physical machines, virtual machines, physical servers, virtual (e.g., cloud) servers, data centers, or other compute resources managed by or otherwise accessible to the identity management system 120.

A user 185 may interact with the computing device 105 to communicate with one or more of the on-premises system 115, the identity management system 120, or the cloud system 125. For example, the user 185 may access one or more applications 110 by interacting with an interface 190 of the computing device 105. In some implementations, the user 185 may be prompted to provide some form of identification (such as a password, personal identification number (PIN), biometric information, or the like) before the interface 190 is presented to the user 185. In some implementations, the user 185 may be a developer, customer, employee, vendor, partner, or contractor of a client organization (such as a group, business, enterprise, non-profit, or startup that uses one or more services of the identity management system 120). The applications 110 may include one or more on-premises applications 110 (hosted by the on-premises system 115), mobile applications 110 (configured for mobile devices), and/or one or more cloud applications 110 (hosted by the cloud system 125).

The SSO service 155 of the identity management system 120 may allow the user 185 to access multiple applications 110 with one or more credentials. Once authenticated, the user 185 may access one or more of the applications 110 (for example, via the interface 190 of the computing device 105). That is, based on the identity management system 120 authenticating the identity of the user 185, the user 185 may obtain access to multiple applications 110, for example, without having to re-enter the credentials (or enter other credentials). The SSO service 155 may leverage one or more authentication protocols, such as Security Assertion Markup Language (SAML) or OpenID Connect (OIDC), among other examples of authentication protocols. In some examples, the user 185 may attempt to access an application 110 via a browser. In such examples, the browser may be redirected to the SSO service 155 of the identity management system 120, which may serve as the identity provider (IdP). For example, in some implementations, the browser (e.g., the user's request communicated via the browser) may be redirected by an access gateway 130 (e.g., a reverse proxy-based virtual application configured to secure web applications 110 that may not natively support SAML or OIDC).

In some examples, the access gateway 130 may support integrations with legacy applications 110 using hypertext transfer protocol (HTTP) headers and Kerberos tokens, which may offer universal resource locator (URL)-based authorization, among other functionalities. In some examples, such as in response to the user's request, the IdP may prompt the user 185 for one or more credentials (such as a password, PIN, biometric information, or the like) and the user 185 may provide the requested authentication credentials to the IdP. In some implementations, the IdP may leverage the MFA service 160 for added security. The IdP may verify the user's identity by comparing the credentials provided by the user 185 to credentials associated with the user's account. For example, one or more credentials associated with the user's account may be registered with the IdP (e.g., previously registered, or otherwise authorized for authentication of the user's identity via the IdP). The IdP may generate a security token (such as a SAML token or Oath 2.0 token) containing information associated with the identity and/or authentication status of the user 185 based on successful authentication of the user's identity.

The IdP may send the security token to the computing device 105 (e.g., the browser or application 110 running on the computing device 105). In some examples, the application 110 may be associated with a service provider (SP), which may host or manage the application 110. In such examples, the computing device 105 may forward the token to the SP. Accordingly, the SP may verify the authenticity of the token and determine whether the user 185 is authorized to access the requested applications 110. In some examples, such as examples in which the SP determines that the user 185 is authorized to access the requested application, the SP may grant the user 185 access to the requested applications 110, for example, without prompting the user 185 to enter credentials (e.g., without prompting the user to log-in). The SSO service 155 may promote improved user experience (e.g., by limiting the number of credentials the user 185 has to remember/enter), enhanced security (e.g., by leveraging secure authentication protocols and centralized security policies), and reduced credential fatigue, among other benefits.

The MFA service 160 of the identity management system 120 may enhance the security of the computing system 100 by prompting the user 185 to provide multiple authentication factors before granting the user 185 access to applications 110. These authentication factors may include one or more knowledge factors (e.g., something the user 185 knows, such as a password), one or more possession factors (e.g., something the user 185 is in possession of, such as a mobile app-generated code or a hardware token), or one or more inherence factors (e.g., something inherent to the user 185, such as a fingerprint or other biometric information). In some implementations, the MFA service 160 may be used in conjunction with the SSO service 155. For example, the user 185 may provide the requested login credentials to the identity management system 120 in accordance with an SSO flow and, in response, the identity management system 120 may prompt the user 185 to provide a second factor, such as a possession factor (e.g., a one-time passcode (OTP), a hardware token, a text message code, an email link/code). The user 185 may obtain access (e.g., be granted access by the identity management system 120) to the requested applications 110 based on successful verification of both the first authentication factor and the second authentication factor.

The API service 165 of the identity management system 120 can secure APIs by managing access tokens and API keys for various client organizations, which may enable (e.g., only enable) authorized applications (e.g., one or more of the applications 110) and authorized users (e.g., the user 185) to interact with a client organization's APIs. The API service 165 may enable client organizations to implement customizable login experiences that are consistent with their architecture, brand, and security configuration. The API service 165 may enable administrators to control user API access (e.g., whether the user 185 and/or one or more other users have access to one or more particular APIs). In some examples, the API service 165 may enable administrators to control API access for users via authorization policies, such as standards-based authorization policies that leverage OAuth 2.0. The API service 165 may additionally, or alternatively, implement role-based access control (RBAC) for applications 110. In some implementations, the API service 165 can be used to configure user lifecycle policies that automate API onboarding and off-boarding processes.

The directory management service 170 may enable the identity management system 120 to integrate with various identity sources of client organizations. In some implementations, the directory management service 170 may communicate with a directory service 145 of the on-premises system 115 via a software agent 150 installed on one or more computers, servers, and/or devices of the on-premises system 115. Additionally, or alternatively, the directory management service 170 may communicate with one or more other directory services, such as one or more cloud-based directory services. As described herein, a software agent 150 generally refers to a software program or component that operates on a system or device (such as a device of the on-premises system 115) to perform operations or collect data on behalf of another software application or system (such as the identity management system 120).

The provisioning service 175 of the identity management system 120 may support user provisioning and deprovisioning. For example, in response to an employee joining a client organization, the identity management system 120 may automatically create accounts for the employee and provide the employee with access to one or more resources via the accounts. Similarly, in response to the employee (or some other employee) leaving the client organization, the identity management system 120 may autonomously deprovision the employee's accounts and revoke the employee's access to the one or more resources (e.g., with little to no intervention from the client organization). The provisioning service 175 may maintain audit logs and records of user deprovisioning events, which may help the client organization demonstrate compliance and track user lifecycle changes. In some implementations, the provisioning service 175 may enable administrators to map user attributes and roles (e.g., permissions, privileges) between the identity management system 120 and connected applications 110, ensuring that user profiles are consistent across the identity management system 120, the on-premises system 115, and the cloud system 125.

Although not depicted in the example of FIG. 1, a person skilled in the art would appreciate that the identity management system 120 may support or otherwise provide access to any number of additional or alternative services, applications 110, platforms, providers, or the like. In other words, the functionality of the identity management system 120 is not limited to the exemplary components and services mentioned in the preceding description of the computing system 100. The description herein is provided to enable a person skilled in the art to make or use the present disclosure. Various modifications to the present disclosure will be readily apparent to those skilled in the art, and the generic principles defined herein may be applied to other variations without departing from the scope of the present disclosure. Accordingly, the present disclosure is not limited to the examples and designs described herein, but is to be accorded the broadest scope consistent with the principles and novel features disclosed herein.

As described herein, the user 185 of the computing device 105 may access a resource of an organization based on a previously performed authorization procedure for a different resource and/or context (e.g., a different browser or application). The resource may be an example of resources on application 110, such as applications of an organization. After performing a first authorization procedure to establish a first session at the computing device 105, an authorization server may store a record of one or more parameters associated with the first session. The authorization server may be an example of a server of the identity management system 120. When the user 185 attempts to access a resource of a different application 110 and/or access resources from a different context on the computing device 105, the authorization server may issue an authentication challenge. An authenticator application at the computing device 105 may intercept the challenge and transmit a response to the authorization server including at least a token associated with the first session. The authorization server may determine whether the first session satisfies an assurance level associated with the different resource and/or context and either link a second session with the different resource and/or context to the first session (e.g., based on the assurance level being satisfied) or perform a second authorization procedure (e.g., based on the assurance level not being satisfied).

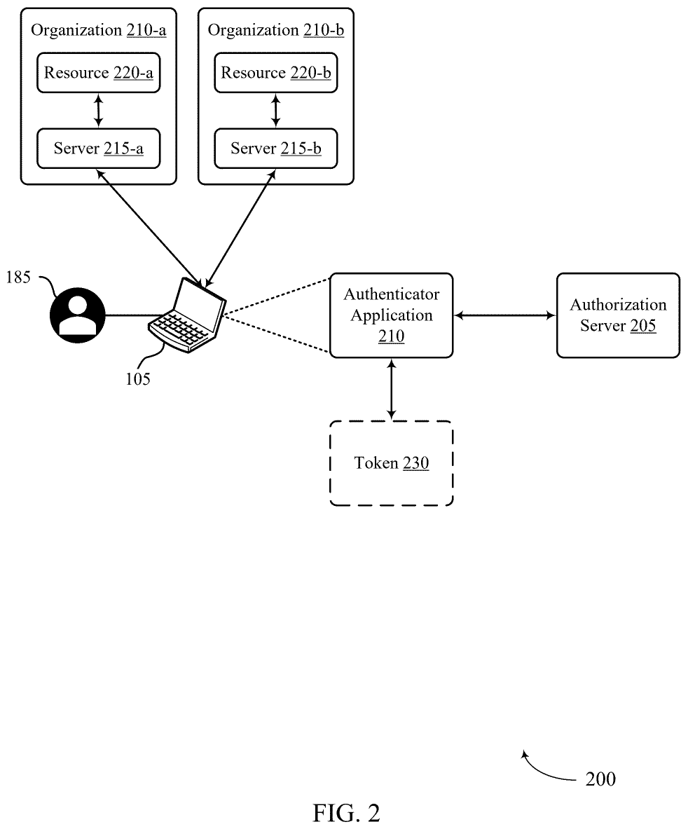

FIG. 2 shows an example of a computing system 200 that supports multi-application SSO via device session establishment in accordance with aspects of the present disclosure. In some examples, the computing system 200 may implement or be implemented by aspects of the computing system 100. For example, the computing system 200 may include an authorization server 205, which may be an example of a server of the identity management system 120 as described with reference to FIG. 1. Additionally, the computing system 200 may include a user 185 and a computing device 105, which may be examples of the user 185 and the computing device 105 as described with reference to FIG. 1.

The user 185 of the computing device 105 may attempt to access a resource 220-a of an organization 210-a. To access the resource 220-a, the computing device 105 may request access to the resource 220-a from the authorization server 205. In some examples, an authenticator application 210 on the computing device 105 may transmit the request to the authorization server 205 to access the resource 220-a.

The authenticator application 210 may be an example of an application of the authorization server 205. For example, the authenticator application may be registered with the authorization server 205 via a hardware-backed private key. The authenticator application 210 may display prompts for the user 185 to input information for an authorization procedure with the authorization server 205. For example, the authenticator application 210 may display a prompt to input a password, provide a biometric (e.g., fingerprint, facial recognition, etc.), confirm a sign-on request, or the like. The authenticator application 210 may respond to authentication challenges from the authorization server 205. In some examples, the authenticator application 210 may respond to authentication challenges from the authorization server 205 based on receiving user inputs in response to prompting the user to provide inputs for the authorization procedure.

For example, the authenticator application 210 may receive an authentication challenge from the authorization server 205 after transmitting the request to access the resource 220-a. The authenticator application 210 may prompt the user to provide inputs associated with an authentication policy, such as an MFA policy, of the organization 210-a (e.g., configured by the organization 210-a). In other words, the computing device 105 may prompt the user 185, via a user interface of the authenticator application 210, to input information associated with at least two factors of multiple factors of an MFA procedure. As an example, the multiple factors of the MFA procedure may include a password, one or more security questions, SMS verification, voice verification, email verification, push verification via the authenticator application 210, possession of a cryptographic key (e.g., the user-bound key), or any combination thereof. The MFA policy of the organization 210-a may indicate which factors are to be provided by the user 185 to access the resource 220-a. Additionally, the MFA policy may be associated with an assurance level.

After prompting the user 185 to input the information, the computing device 105 may receive user inputs indicative of the at least two factors. The authenticator application 210 may respond to the authentication challenge based on receiving the user inputs. For example, the authenticator application 210 may transmit a response to the authentication challenge including information associated with the user inputs indicative of the at least two factors. The authorization server 205 may establish a session between a server 215-a of the organization 210-a and the computing device 105 based on receiving the response to the authentication challenge. In some examples, as a result of establishing the session with the server 215-a via the authorization procedure (e.g., including the MFA procedure), the computing device 105 may obtain a token 230. For example, the computing device 105 may obtain the token 230 from the authorization server 205 after transmitting the response to the authentication challenge (e.g., via the authenticator application 210), where the token 230 may be a link to the session between the server 215-a and the computing device 105. In some examples, the token 230 may be a JavaScript Object Notation (JSON) Web Token (JWT) or another type of token. Additionally, or alternatively, the token 230 may be signed, such as by the device-bound key, the user-bound key, or both. For example, the token 230 may be a device-bound token. That is, the token 230 may not be exported or used on another device (e.g., a device different than the computing device 105). The token 230 may be device-bound via cryptographic hardware, such as via including a signature from the device-bound key.

The user 185 of the computing device 105 may attempt to access a resource 220-b of an organization 210-b after establishing the session with the server 215-a. To access the resource 220-b, the computing device 105 may request access to the resource 220-b from the authorization server 205. The authenticator application 210 on the computing device 105 may transmit the request to the authorization server 205 to access the resource 220-b. In response to transmitting the request, the computing device 105 may receive an authentication challenge from the authorization server 205. The authenticator application 210 may intercept the authentication challenge and transmit a response. For example, after establishing an initial session on the computing device (e.g., the session with the server 215-a) via an authorization procedure, the authenticator application 210 may respond to authentication challenges from the authorization server 205 without user input (e.g., silently) or with reduced user input relative to the initial authorization procedure.

For example, the authenticator application 210 may respond to authentication challenges with the token 230 associated with the existing session with the server 215-a at the computing device 105. The response may include an origin of the request (e.g., to support phishing resistance), data associated with a security posture of the computing device 105, a first attestation signed by a device-bound key (e.g., a key of the computing device 105, such as a non-removable hardware key), a second attestation signed by a user-bound key (e.g., a key of the user 185), the token 230, or any combination thereof.

The authorization server 205 may determine whether the session with the server 215-a satisfies an assurance level of the organization 210-b based on receiving the response including the token 230. The assurance level may be associated with a type of factor, an amount of factors, or both associated with an MFA procedure. As an example, a biometric may have a higher assurance level than a security question. In some examples, different user inputs for a type of factor may be associated with a same assurance level. For example, different biometric types, such as fingerprint or facial recognition, may have a same assurance level or different security questions may have a same assurance level. The authenticator application 210 may compare factors provided by the user 185 to establish the session with the server 215-a with factors indicated by an authentication policy of the organization 210-b (e.g., configured by the organization 210-b) to determine whether the token 230 may be used to establish a session with the server 215-b. In examples in which the user 185 provided factors indicated by the authentication policy (e.g., an MFA policy) of the organization 210-b to establish the session with the server 215-a of the organization 210-a, the authorization server 205 may establish a session for the computing device 105 with the server 215-b, where the session is linked to the existing session with the server 215-a. That is, because the user 185 previously (e.g., within a threshold duration of time) completed an MFA procedure including factors required by an MFA policy of the organization 210-b, the authorization server 205 may accept the token 230 without the user 185 providing those authentication factors again.

Alternatively, in examples in which the user 185 did not previously complete one or more factors indicated by the authentication policy of the organization 210-b, the authenticator application 210 may prompt the user 185 to provide inputs to satisfy the authentication policy of the organization 210-b (i.e., “step up”). As an example, if the MFA procedure to establish the session with the server 215-a involved a password and a biometric, and if the MFA policy of the organization 210-b indicates a biometric and an SMS verification, the authenticator application 210 may prompt the user 185 to provide SMS verification (e.g., but not a biometric) to establish the session with the server 215-b. That is, the user 185 may provide factors which were not previously completed to establish additional sessions after initial session establishment.

The additional factors provided to establish the session with the server 215-b may be referenced when the token 230 is used to access additional resources. For example, user 185 may request access to one or more other resources of different organizations (not shown), and the authenticator application 210 may respond to authentication challenges associated with the access requests with the token 230. The authorization server 205 may compare assurance levels of multiple sessions associated with the token 230 (e.g., linked sessions), including the session with the server 215-a and the server 215-b in the example of FIG. 2. In examples in which the user 185 provided additional factors when establishing the session with the server 215-b, those additional factors may contribute to an overall assurance level associated with the multiple sessions linked to the token 230. That is, as an example, the multiple sessions linked to the token 230 may include information indicative of the user 185 having completed password entry, biometric verification, and SMS verification, where different factors may have been provided for access to different servers (e.g., in different authorization procedures). In such examples, the different factors may have different expiration times. For example, factors provided in a first authorization procedure (e.g., in time) may expire prior to factors provided in a subsequent authorization procedure. Additionally, or alternatively, different factors may be associated with different expiration times, such as based on a policy of an organization.

The server 215-a and the server 215-b may each include a record with information associated with the respective sessions with the computing device 105. For example, the authorization server 205 may access the records via the token 230 to determine whether an assurance level is satisfied for establishing a session with an additional server. The records may include information associated with factors provided by the user 185, timestamps for each factor, a timestamp associated with a start of the session, or the like. In some examples, the authorization server 205 may determine whether a factor, session, or both has expired based on the timestamps. For example, different servers may support different policies for longevity of factors or sessions. As an example, an authorization policy of the server 215-b may indicate a first time duration associated with expiry of a factor. If the user 185 attempts to access the resource 220-b of the server 215-b after the first time duration from providing the factor, the user 185 may have to provide the factor again.

While the example of FIG. 2 illustrates and describes additional sessions being linked to an initially established session with the server 215-a, it may be noted that the initial session may be established directly with the authorization server 205. In other words, the computing device 105 may establish a session (e.g., a device session) directly with the authorization server 205, where subsequent requests to access resources (e.g., the resource 220-a, the resource 220-b, etc.) are evaluated based on an assurance level associated with the device session (e.g., the pre-established session) with the authorization server 205. In some examples, session establishment with the authorization server 205 may not involve requesting access to a resource. That is, the device session as described herein may be established after access to a resource is requested or without access to a resource being requested.

Additionally, while the example of FIG. 2 illustrates and describes the user 185 accessing the resource 220-b of the organization 210-b after establishing a session with the server 215-a of the organization 210-a, it may be noted that the authenticator application 210 may use the token 230 to access resources within a same organization. For example, after establishing an initial session with the server 215-a, the user 185 may request access to a different resource (e.g., different than the resource 220-a). That is, with reference to FIG. 2, the resource 220-b may, in some examples, be a resource of the organization 210-a. In other words, the organization 210-a and the organization 210-b may be the same or different. Additionally, or alternatively, the authenticator application 210 may use the token 230 to access resources from a different context on the computing device 105.

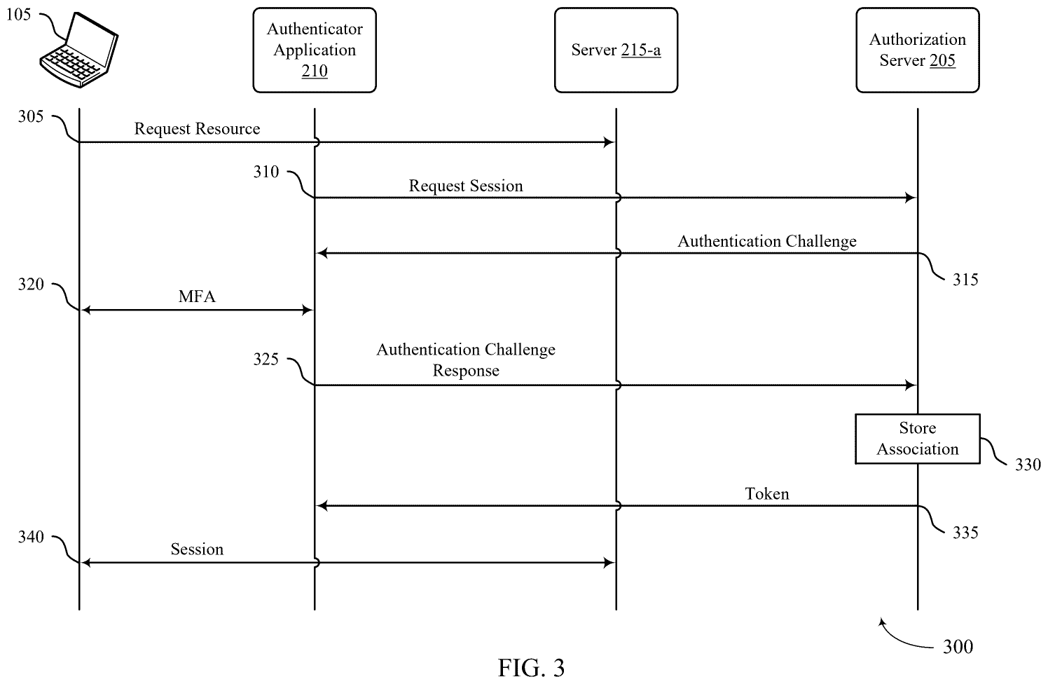

FIG. 3 shows an example of a process flow 300 that supports multi-application SSO via device session establishment in accordance with aspects of the present disclosure. In some examples, the process flow 300 may implement aspects of the computing system 100, the computing system 200, or both. The process flow 300 may illustrate operations of a computing device 105, an authenticator application 210, a server 215-a, and an authorization server 205, which may be examples of corresponding devices as described with reference to FIG. 2.

In the following description of the process flow 300, the operations performed at the computing device 105, the authenticator application 210, the server 215-a, and the authorization server 205 may be performed in different orders or at different times than shown. While the operations of the process flow 300 are illustrated and described as being performed by the computing device 105, the authenticator application 210, the server 215-a, and the authorization server 205, the operations described herein may be performed at one or more other devices or systems. Additionally, or alternatively, some operations may be omitted from the process flow 300 and other operations may be added to the process flow 300.

At 305, the computing device 105 may request a resource of the server 215-a. For example, a user of the computing device 105 may attempt to access a resource of an organization associated with the server 215-a. The resource of the organization may be an example of the resource 220-a of the organization 210-a as described with reference to FIG. 2.

At 310, the authenticator application 210 may request a session from the authorization server 205. For example, to access the resource, the authenticator application 210 may request access to the resource from the authorization server 205. At 315, in response to receiving the request, the authorization server 205 may transmit an authentication challenge to the authentication application. The authentication challenge may be associated with an authentication policy of the organization. For example, the authentication challenge may request that the user perform one or more authorization factors in an MFA procedure.

At 320, the computing device 105 and the authenticator application 210 may perform MFA. Performing the MFA may include prompting, via a user interface of the authenticator application 210, a user of the computing device 105 to input information associated with at least two factors of multiple factors of the MFA procedure. Additionally, performing the MFA may include receiving, after prompting the user to input the information, one or more user inputs indicative of at least two factors. In other words, the user may provide inputs, such as a password, biometric, or another factor included in the at least two factors in response to being prompted to input the information associated with the at least two factors. The MFA may be a part of a first authorization procedure, where the first authorization procedure is in accordance with an MFA policy, a device posture policy, or both associated with the computing device 105, the first organization, or both.

At 325, the authenticator application 210 may transmit an authentication challenge response to the authorization server 205. For example, the authenticator application 210 may transmit a response indicating the information received via the one or more user inputs during the MFA procedure at 320. At 330, after receiving the response, the authorization server 205 may store an association. For example, the authorization server 205 may store an association between the computing device 105 and/or the user and the session with the server 215-a.

At 335, the authenticator application 210 may receive a token from the authorization server 205. In other words, the authenticator application 210 may receive, from the authorization server 205, a token indicative of the session with the server. The token may be an example of the token 230 as described with reference to FIG. 2.

At 340, the computing device 105 may establish a session with the server 215-a. That is, after transmitting the authentication challenge response at 325, the computing device 105 may access the resource requested at 305. The session may include a record of information associated with the session establishment. For example, the record may include an indication of the MFA procedure, a timestamp associated with the MFA procedure, a timestamp associated with the session establishment, or the like.

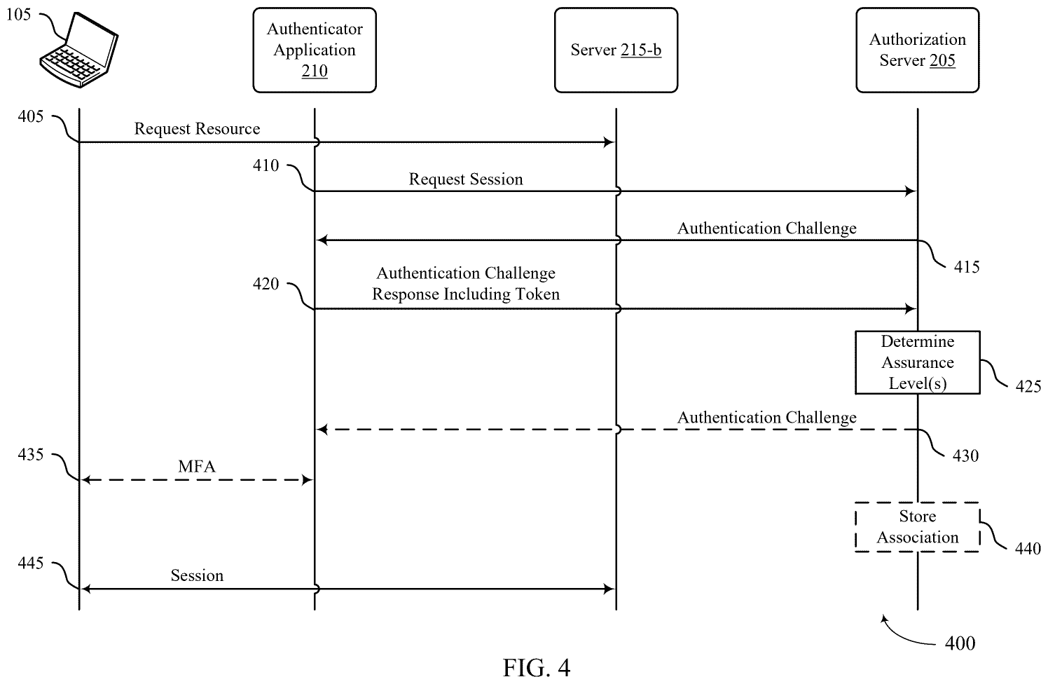

FIG. 4 shows an example of a process flow 400 that supports multi-application SSO via device session establishment in accordance with aspects of the present disclosure. In some examples, the process flow 400 may implement aspects of the computing system 100, the computing system 200, or both. The process flow 300 may illustrate operations of a computing device 105, an authenticator application 210, a server 215-b, and an authorization server 205, which may be examples of corresponding devices as described with reference to FIG. 2.

In the following description of the process flow 400, the operations performed at the computing device 105, the authenticator application 210, the server 215-b, and the authorization server 205 may be performed in different orders or at different times than shown. While the operations of the process flow 400 are illustrated and described as being performed by the computing device 105, the authenticator application 210, the server 215-b, and the authorization server 205, the operations described herein may be performed at one or more other devices or systems. Additionally, or alternatively, some operations may be omitted from the process flow 400 and other operations may be added to the process flow 400.

The process flow 400 may illustrate a session establishment with a server 215-b after a user has established a session with another server, such as with the server 215-a as described with reference to FIG. 3. That is, the operations of the process flow 400 may occur after, in time, the operations of the process flow 300. One or more operations of the process flow 400 may refer to a device-bound token associated with a first session. The first session may refer to the session established with the server 215-a via the operations of the process flow 300. In other words, prior to the operations of the process flow 400, the computing device 105, the authenticator application 210, or both may transmit signaling to the authorization server 205 for a first authorization procedure to establish a first session between the computing device 105 and the server 215-a of a first organization (e.g., as shown with respect to the operations of the process flow 300). In some examples, the first session may be established during or after user login to the computing device 105. That is, the first authorization procedure described with reference to FIG. 3 may be during or after login to the computing device 105.

At 405, the computing device 105 may request to access a resource of the server 215-b. For example, a user of the computing device 105 may attempt to access a resource of an organization associated with the server 215-b. The resource of the organization may be an example of the resource 220-b of the organization 210-b as described with reference to FIG. 2. After the computing device 105 attempts to access the resource of the server 215-b, the authenticator application 210 may transmit a request to the authorization server 205. For example, at 410, the authenticator application 210 may transmit, to the authorization server 205, a request to access a resource of an organization after establishing a first session (e.g., as described with reference to the process flow 300). Additionally, or alternatively, the first session may be established with the authorization server 205. That is, the computing device 105 may establish the first session with the authorization server 205 prior to the operations of the process flow 400.

At 415, the authorization server 205 may transmit an authentication challenge to the authenticator application 210. For example, the authenticator application 210 may receive an authentication challenge from the authorization server 205. In some examples, the authenticator application 210 may intercept the authentication challenge, where the authentication challenge is issued to the computing device 105.

At 420, the authenticator application 210 may transmit an authentication challenge response including a token. For example, the authenticator application 210 may transmit, to the authorization server 205, a response to the authentication challenge including a token indicative of the first session established via the first authorization procedure e.g., as described with reference to the process flow 300). The response to the authentication challenge may include, in addition to the token, an origin of the request, information associated with a security posture of the computing device 105, a first attestation signed via a device-bound key, a second attestation signed via a user-bound key, or any combination thereof.

At 425, the authorization server 205 may determine assurance levels. For example, the authorization server 205 may determine whether the first session associated with the token satisfies an assurance level associated with access to the server 215-b. In examples in which the first session satisfies the assurance level, the authorization server 205 may establish the second session between the computing device 105 and the server 215-b based on determining that the first session associated with the token satisfies the assurance level. Alternatively, in examples in which the first session fails to satisfy the assurance level, the authorization server 205 may initiate an additional authorization procedure.

For example, at 430, the authenticator application 210 may receive an authentication challenge (e.g., an additional authentication challenge). At 435, the computing device 105 and the authenticator application 210 may perform MFA. Performing the MFA may include prompting, via a user interface of the authenticator application 210, a user of the computing device 105 to input information associated with factors of the MFA procedure. Additionally, performing the MFA may include receiving, after prompting the user to input the information, one or more user inputs indicative of the factors. In some examples, the MFA procedure may include factors which were not included in the MFA procedure performed for the server 215-a (e.g., at 320 of the process flow 300).

In other words, the computing device 105, the authenticator application 210, and the authorization server 205 may perform a second authorization procedure to establish the second session between the computing device 105 and the server 215-a based on determining that the first session associated with the token fails to satisfy the assurance level at 425. In examples in which the authorization server 205 performs the additional authorization procedure, the authorization server 205 may establish the second session between the computing device 105 and the server 215-b based on receiving the response to the authentication challenge including the token at 420 and performing the second authorization procedure at 430 and 435, where a combination of the first authorization procedure associated with the first session and the second authorization procedure associated with the second session satisfy the assurance level.

At 440, after receiving the authentication challenge response at 420 and/or performing the second authorization procedure at 430 and 435, the authorization server 205 may store an association. For example, the authorization server 205 may store an association between the computing device 105 and/or the user and the session with the server 215-b.

At 445, the computing device 105 may establish a session with the server 215-b. For example, after transmitting the authentication challenge response at 420, the computing device 105 may access the resource requested at 405. In other words, the computing device 105 may establish a second session between the computing device 105 and the server 215-b based on transmitting the response to the authentication challenge, where the second session is associated with the first session in accordance with the response to the authentication challenge including the token. In some examples, establishing the second session may be based on the first session satisfying a policy associated with the server 215-b, the policy indicating a time duration for which the token associated with the first session is usable to establish sessions with the server 215-b. In other words, the authorization server 205 may establish the session at 445 based on receiving the authentication challenge response including the token at 420 within the time duration indicated by the policy of the server 215-b.

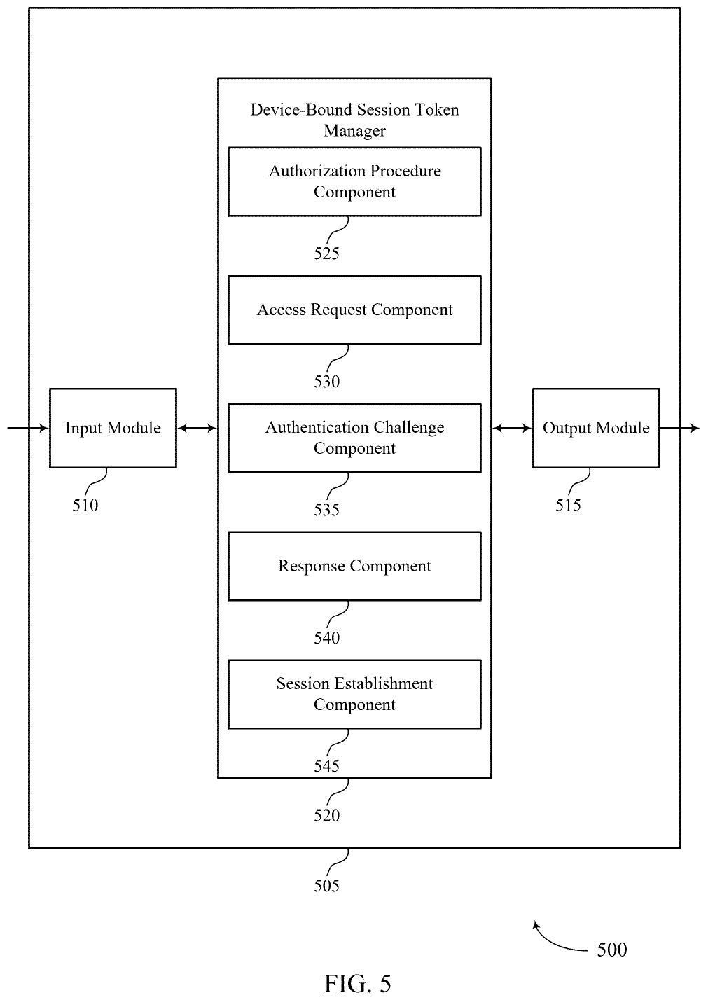

FIG. 5 shows a block diagram 500 of a device 505 that supports multi-application SSO via device session establishment in accordance with aspects of the present disclosure. The device 505 may include an input module 510, an output module 515, and a device-bound session token manager 520. The device 505, or one or more components of the device 505 (e.g., the input module 510, the output module 515, the device-bound session token manager 520), may include at least one processor, which may be coupled with at least one memory, to support the described techniques. Each of these components may be in communication with one another (e.g., via one or more buses).

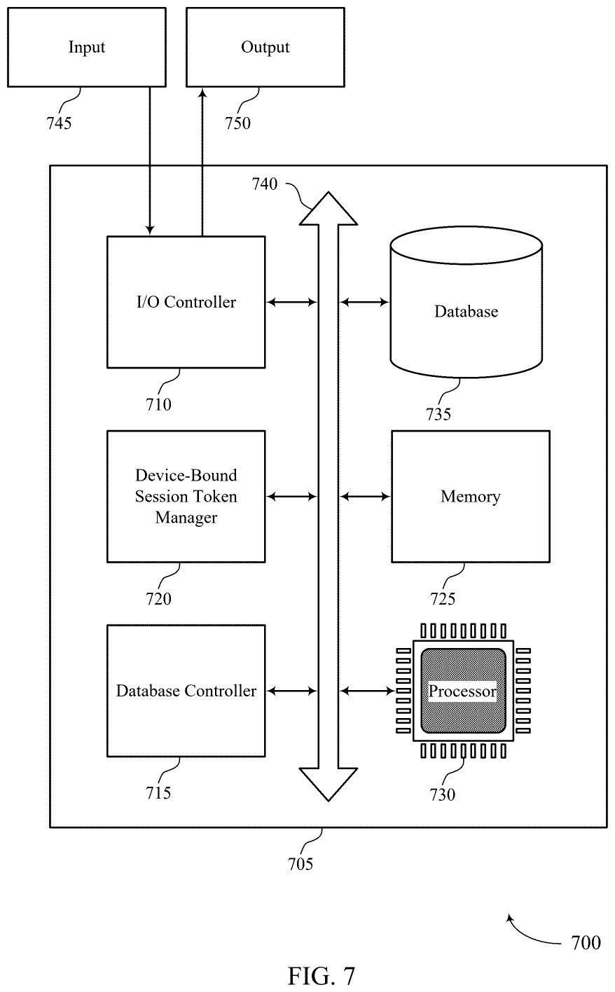

The input module 510 may manage input signals for the device 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the device 505 for processing. For example, the input module 510 may transmit input signals to the device-bound session token manager 520 to support multi-application SSO via device session establishment. In some cases, the input module 510 may be a component of an input/output (I/O) controller 710 as described with reference to FIG. 7.

The output module 515 may manage output signals for the device 505. For example, the output module 515 may receive signals from other components of the device 505, such as the device-bound session token manager 520, and may transmit these signals to other components or devices. In some examples, the output module 515 may transmit output signals for display in a user interface, for storage in a database or data store, for further processing at a server or server cluster, or for any other processes at any number of devices or systems. In some cases, the output module 515 may be a component of an I/O controller 710 as described with reference to FIG. 7.

For example, the device-bound session token manager 520 may include an authorization procedure component 525, an access request component 530, an authentication challenge component 535, a response component 540, a session establishment component 545, or any combination thereof. In some examples, the device-bound session token manager 520, or various components thereof, may be configured to perform various operations (e.g., receiving, monitoring, transmitting) using or otherwise in cooperation with the input module 510, the output module 515, or both. For example, the device-bound session token manager 520 may receive information from the input module 510, send information to the output module 515, or be integrated in combination with the input module 510, the output module 515, or both to receive information, transmit information, or perform various other operations as described herein.

The device-bound session token manager 520 may support establishing sessions via an authorization server in accordance with examples as disclosed herein. The authorization procedure component 525 may be configured to support transmitting signaling to the authorization server for a first authorization procedure to establish a first session between a user device and a first server of a first organization. The access request component 530 may be configured to support transmitting, to the authorization server, a request to access a resource after establishing the first session. The authentication challenge component 535 may be configured to support receiving, by an authenticator application of the user device, an authentication challenge from the authorization server. The response component 540 may be configured to support transmitting, to the authorization server, a response to the authentication challenge including a token indicative of the first session established via the first authorization procedure. The session establishment component 545 may be configured to support establishing a second session between the user device and a second server based on transmitting the response to the authentication challenge, where the second session is associated with the first session in accordance with the response to the authentication challenge including the token.

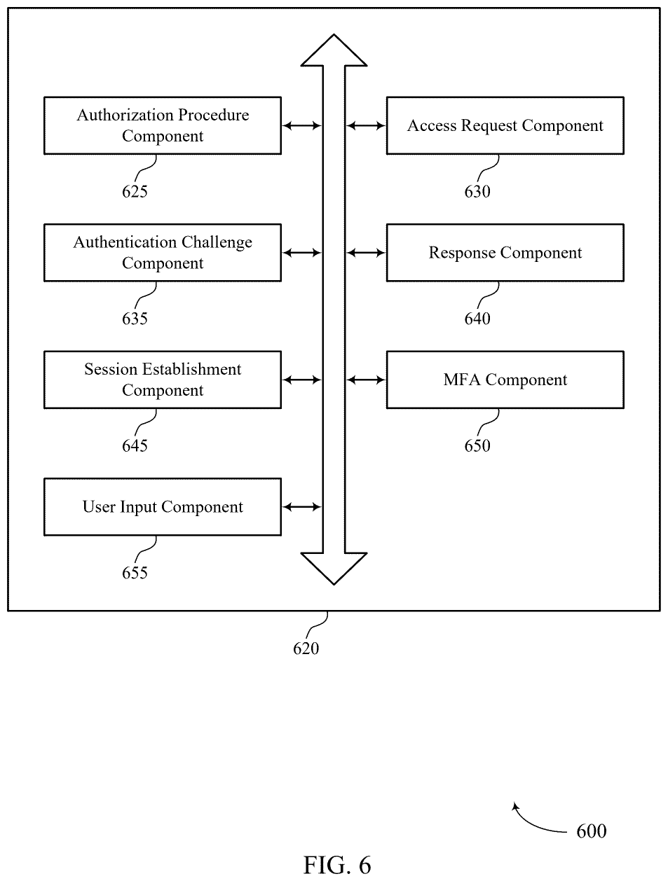

FIG. 6 shows a block diagram 600 of a device-bound session token manager 620 that supports multi-application SSO via device session establishment in accordance with aspects of the present disclosure. The device-bound session token manager 620 may be an example of aspects of a device-bound session token manager or a device-bound session token manager 520, or both, as described herein. The device-bound session token manager 620, or various components thereof, may be an example of means for performing various aspects of multi-application SSO via device session establishment as described herein. For example, the device-bound session token manager 620 may include an authorization procedure component 625, an access request component 630, an authentication challenge component 635, a response component 640, a session establishment component 645, an MFA component 650, a user input component 655, or any combination thereof. Each of these components, or components of subcomponents thereof (e.g., one or more processors, one or more memories), may communicate, directly or indirectly, with one another (e.g., via one or more buses).

The device-bound session token manager 620 may support establishing sessions via an authorization server in accordance with examples as disclosed herein. The authorization procedure component 625 may be configured to support transmitting signaling to the authorization server for a first authorization procedure to establish a first session between a user device and a first server of a first organization. The access request component 630 may be configured to support transmitting, to the authorization server, a request to access a resource after establishing the first session. The authentication challenge component 635 may be configured to support receiving, by an authenticator application of the user device, an authentication challenge from the authorization server. The response component 640 may be configured to support transmitting, to the authorization server, a response to the authentication challenge including a token indicative of the first session established via the first authorization procedure. The session establishment component 645 may be configured to support establishing a second session between the user device and a second server based on transmitting the response to the authentication challenge, where the second session is associated with the first session in accordance with the response to the authentication challenge including the token.

In some examples, to support establishing the second session based on transmitting the response including the token, the session establishment component 645 may be configured to support establishing the second session between the user device and the second server based on transmitting the response including the token and based on the first session associated with the token satisfying an assurance level associated with access to the second server.

In some examples, the authorization procedure component 625 may be configured to support transmitting second signaling to the authorization server for a second authorization procedure to establish the second session between the user device and the second server, where transmitting the second signaling is based on the first session associated with the token failing to satisfy an assurance level associated with access to the second server. In some examples, the session establishment component 645 may be configured to support establishing the second session between the user device and the second server based on transmitting the response to the authentication challenge including the token and the second authorization procedure, where a combination of the first authorization procedure associated with the first session and the second authorization procedure associated with the second session satisfy the assurance level.

In some examples, establishing the second session is based on the first session satisfying a policy associated with the second server, the policy indicating a time duration for which the token associated with the first session is usable to establish sessions with the second server.

In some examples, the first authorization procedure includes a MFA procedure, and the MFA component 650 may be configured to support prompting, via a user interface of the authenticator application, a user of the user device to input information associated with at least two factors of a set of multiple factors of the MFA procedure. In some examples, the first authorization procedure includes a MFA procedure, and the user input component 655 may be configured to support receiving, after prompting the user to input the information, one or more user inputs indicative of the at least two factors, where transmitting the signaling to the authorization server is based on receiving the one or more user inputs.

In some examples, the set of multiple factors include a password, one or more security questions, SMS verification, voice verification, email verification, push verification via the authenticator application, possession of a cryptographic key, or any combination thereof.

In some examples, receiving the authentication challenge from the authorization server by the authenticator application includes intercepting the authentication challenge transmitted from the authorization server to the user device.

In some examples, to support transmitting the signaling to the authorization server, the authorization procedure component 625 may be configured to support transmitting the signaling to the authorization server during or after a user login to the user device.

In some examples, the response to the authentication challenge further includes an origin of the request, information associated with a security posture of the user device, a first attestation signed via a device-bound key, a second attestation signed via a user-bound key, or any combination thereof.

In some examples, the authenticator application is registered with the authorization server via a hardware-backed private key.

In some examples, the user device is associated with a user having a second private key.

In some examples, the first authorization procedure is in accordance with a MFA policy, a device posture policy, or both associated with the user device, the first organization, or both.

FIG. 7 shows a diagram of a system 700 including a device 705 that supports multi-application SSO via device session establishment in accordance with aspects of the present disclosure. The device 705 may be an example of or include components of a device 505 as described herein. The device 705 may include components for bi-directional voice and data communications including components for transmitting and receiving communications, such as a device-bound session token manager 720, an I/O controller, such as an I/O controller 710, a database controller 715, at least one memory 725, at least one processor 730, and a database 735. These components may be in electronic communication or otherwise coupled (e.g., operatively, communicatively, functionally, electronically, electrically) via one or more buses (e.g., a bus 740).

The I/O controller 710 may manage input signals 745 and output signals 750 for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. In other cases, the I/O controller 710 may represent or interact with a modem, a keyboard, a mouse, a touchscreen, or a similar device. In some cases, the I/O controller 710 may be implemented as part of a processor 730. In some examples, a user may interact with the device 705 via the I/O controller 710 or via hardware components controlled by the I/O controller 710.

The database controller 715 may manage data storage and processing in a database 735. In some cases, a user may interact with the database controller 715. In other cases, the database controller 715 may operate automatically without user interaction. The database 735 may be an example of a single database, a distributed database, multiple distributed databases, a data store, a data lake, or an emergency backup database.

Memory 725 may include random-access memory (RAM) and read-only memory (ROM). The memory 725 may store computer-readable, computer-executable software including instructions that, when executed, cause at least one processor 730 to perform various functions described herein. In some cases, the memory 725 may contain, among other things, a basic I/O system (BIOS) which may control basic hardware or software operation such as the interaction with peripheral components or devices. The memory 725 may be an example of a single memory or multiple memories. For example, the device 705 may include one or more memories 725.

The processor 730 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in at least one memory 725 to perform various functions (e.g., functions or tasks supporting multi-application SSO via device session establishment). The processor 730 may be an example of a single processor or multiple processors. For example, the device 705 may include one or more processors 730.

The device-bound session token manager 720 may support establishing sessions via an authorization server in accordance with examples as disclosed herein. For example, the device-bound session token manager 720 may be configured to support transmitting signaling to the authorization server for a first authorization procedure to establish a first session between a user device and a first server of a first organization. The device-bound session token manager 720 may be configured to support transmitting, to the authorization server, a request to access a resource after establishing the first session. The device-bound session token manager 720 may be configured to support receiving, by an authenticator application of the user device, an authentication challenge from the authorization server. The device-bound session token manager 720 may be configured to support transmitting, to the authorization server, a response to the authentication challenge including a token indicative of the first session established via the first authorization procedure. The device-bound session token manager 720 may be configured to support establishing a second session between the user device and a second server based on transmitting the response to the authentication challenge, where the second session is associated with the first session in accordance with the response to the authentication challenge including the token.

By including or configuring the device-bound session token manager 720 in accordance with examples as described herein, the device 705 may support techniques for improved security related to accessing resources of organization servers and improved user experience related to authorization procedures.

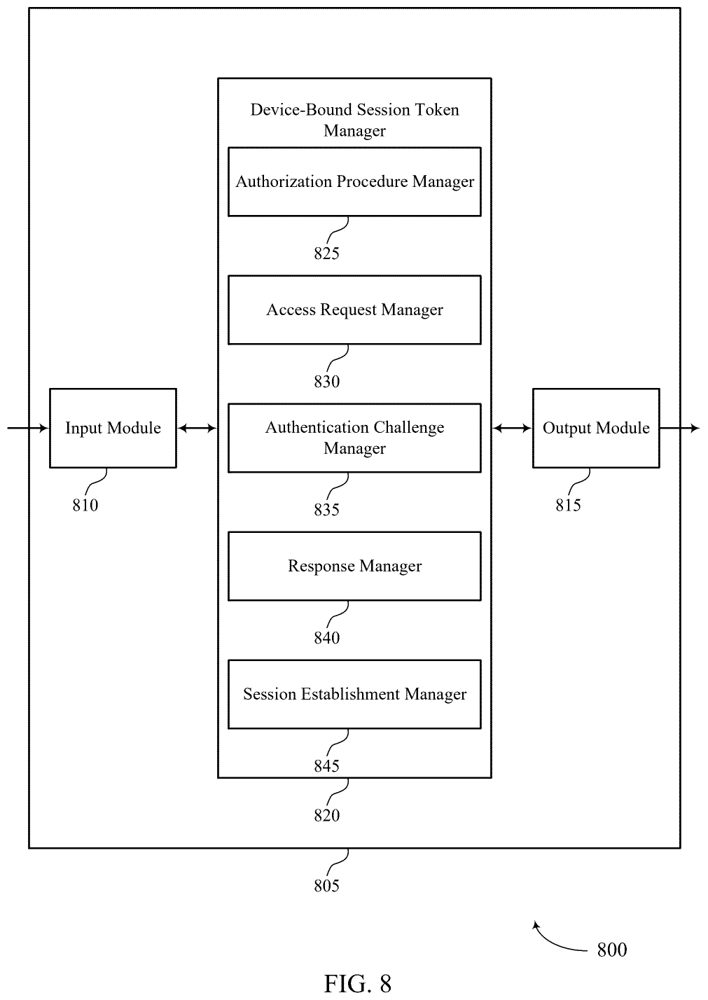

FIG. 8 shows a block diagram 800 of a device 805 that supports multi-application SSO via device session establishment in accordance with aspects of the present disclosure. The device 805 may include an input module 810, an output module 815, and a device-bound session token manager 820. The device 805, or one or more components of the device 805 (e.g., the input module 810, the output module 815, the device-bound session token manager 820), may include at least one processor, which may be coupled with at least one memory, to support the described techniques. Each of these components may be in communication with one another (e.g., via one or more buses).

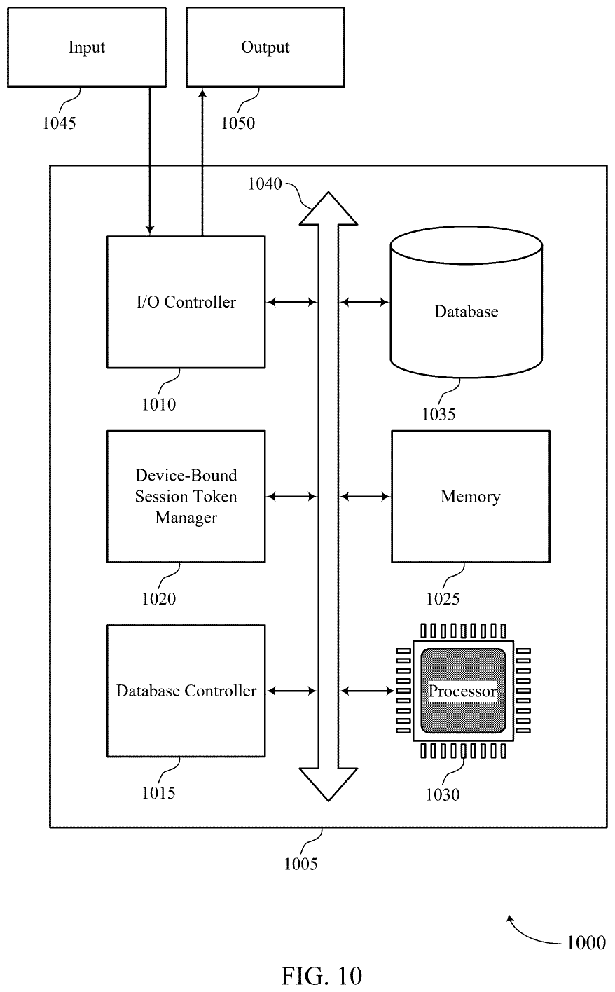

The input module 810 may manage input signals for the device 805. For example, the input module 810 may identify input signals based on an interaction with a modem, a keyboard, a mouse, a touchscreen, or a similar device. These input signals may be associated with user input or processing at other components or devices. In some cases, the input module 810 may utilize an operating system such as iOS®, ANDROID®, MS-DOS®, MS-WINDOWS®, OS/2®, UNIX®, LINUX®, or another known operating system to handle input signals. The input module 810 may send aspects of these input signals to other components of the device 805 for processing. For example, the input module 810 may transmit input signals to the device-bound session token manager 820 to support multi-application SSO via device session establishment. In some cases, the input module 810 may be a component of an input/output (I/O) controller 1010 as described with reference to FIG. 10.

The output module 815 may manage output signals for the device 805. For example, the output module 815 may receive signals from other components of the device 805, such as the device-bound session token manager 820, and may transmit these signals to other components or devices. In some examples, the output module 815 may transmit output signals for display in a user interface, for storage in a database or data store, for further processing at a server or server cluster, or for any other processes at any number of devices or systems. In some cases, the output module 815 may be a component of an I/O controller 1010 as described with reference to FIG. 10.

For example, the device-bound session token manager 820 may include an authorization procedure manager 825, an access request manager 830, an authentication challenge manager 835, a response manager 840, a session establishment manager 845, or any combination thereof. In some examples, the device-bound session token manager 820, or various components thereof, may be configured to perform various operations (e.g., receiving, monitoring, transmitting) using or otherwise in cooperation with the input module 810, the output module 815, or both. For example, the device-bound session token manager 820 may receive information from the input module 810, send information to the output module 815, or be integrated in combination with the input module 810, the output module 815, or both to receive information, transmit information, or perform various other operations as described herein.

The device-bound session token manager 820 may support establishing sessions via an authorization server in accordance with examples as disclosed herein. The authorization procedure manager 825 may be configured to support performing, via the authorization server, a first authorization procedure to establish a first session between a user device and a first server of a first organization. The access request manager 830 may be configured to support receiving, from the user device, a request to access a resource after establishing the first session. The authentication challenge manager 835 may be configured to support transmitting, to the user device, an authentication challenge in response to the request. The response manager 840 may be configured to support receiving, from an authenticator application of the user device, a response to the authentication challenge including a token indicative of the first session established via the first authorization procedure. The session establishment manager 845 may be configured to support establishing a second session between the user device and a second server based on receiving the response to the authentication challenge, where the second session is associated with the first session in accordance with the response to the authentication challenge including the token.

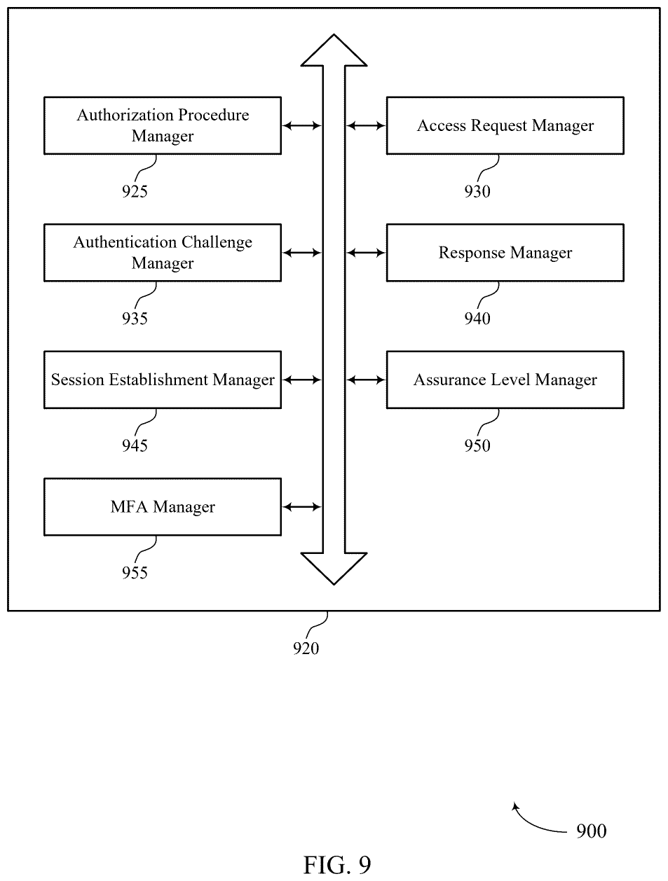

FIG. 9 shows a block diagram 900 of a device-bound session token manager 920 that supports multi-application SSO via device session establishment in accordance with aspects of the present disclosure. The device-bound session token manager 920 may be an example of aspects of a device-bound session token manager or a device-bound session token manager 820, or both, as described herein. The device-bound session token manager 920, or various components thereof, may be an example of means for performing various aspects of multi-application SSO via device session establishment as described herein. For example, the device-bound session token manager 920 may include an authorization procedure manager 925, an access request manager 930, an authentication challenge manager 935, a response manager 940, a session establishment manager 945, an assurance level manager 950, an MFA manager 955, or any combination thereof. Each of these components, or components of subcomponents thereof (e.g., one or more processors, one or more memories), may communicate, directly or indirectly, with one another (e.g., via one or more buses).

The device-bound session token manager 920 may support establishing sessions via an authorization server in accordance with examples as disclosed herein. The authorization procedure manager 925 may be configured to support performing, via the authorization server, a first authorization procedure to establish a first session between a user device and a first server of a first organization. The access request manager 930 may be configured to support receiving, from the user device, a request to access a resource after establishing the first session. The authentication challenge manager 935 may be configured to support transmitting, to the user device, an authentication challenge in response to the request. The response manager 940 may be configured to support receiving, from an authenticator application of the user device, a response to the authentication challenge including a token indicative of the first session established via the first authorization procedure. The session establishment manager 945 may be configured to support establishing a second session between the user device and a second server based on receiving the response to the authentication challenge, where the second session is associated with the first session in accordance with the response to the authentication challenge including the token.

In some examples, the assurance level manager 950 may be configured to support determining that the first session associated with the token satisfies an assurance level associated with access to the second server. In some examples, the session establishment manager 945 may be configured to support establishing the second session between the user device and the second server based on determining that the first session associated with the token satisfies the assurance level.

In some examples, the assurance level manager 950 may be configured to support determining that the first session associated with the token fails to satisfy an assurance level associated with access to the second server. In some examples, the authorization procedure manager 925 may be configured to support performing, via the authorization server, a second authorization procedure to establish the second session between the user device and the second server based on determining that the first session associated with the token fails to satisfy the assurance level. In some examples, the session establishment manager 945 may be configured to support establishing the second session between the user device and the second server based on receiving the response to the authentication challenge including the token and performing the second authorization procedure, where a combination of the first authorization procedure associated with the first session and the second authorization procedure associated with the second session satisfy the assurance level.

In some examples, establishing the second session is based on the first session satisfying a policy associated with the second server, the policy indicating a time duration for which the token associated with the first session is usable to establish sessions with the second server.

In some examples, the first authorization procedure includes a MFA procedure, and the MFA manager 955 may be configured to support receiving information indicative of at least two factors of a set of multiple factors of the MFA procedure, where performing the first authorization procedure includes verifying the at least two factors.

In some examples, the set of multiple factors include a password, one or more security questions, SMS verification, voice verification, email verification, push verification via the authenticator application, possession of a cryptographic key, or any combination thereof.

In some examples, to support performing the first authorization procedure, the authorization procedure manager 925 may be configured to support performing the first authorization procedure during or after a user login to the user device.

In some examples, the response to the authentication challenge further includes an origin of the request, information associated with a security posture of the user device, a first attestation signed via a device-bound key, a second attestation signed via a user-bound key, or any combination thereof.

In some examples, the authenticator application is registered with the authorization server via a hardware-backed private key.

In some examples, the user device is associated with a user having a second private key.

In some examples, the first authorization procedure is in accordance with a MFA policy, a device posture policy, or both associated with the user device, the first organization, or both.

FIG. 10 shows a diagram of a system 1000 including a device 1005 that supports multi-application SSO via device session establishment in accordance with aspects of the present disclosure. The device 1005 may be an example of or include components of a device 805 as described herein. The device 1005 may include components for bi-directional voice and data communications including components for transmitting and receiving communications, such as a device-bound session token manager 1020, an I/O controller, such as an I/O controller 1010, a database controller 1015, at least one memory 1025, at least one processor 1030, and a database 1035. These components may be in electronic communication or otherwise coupled (e.g., operatively, communicatively, functionally, electronically, electrically) via one or more buses (e.g., a bus 1040).

The I/O controller 1010 may manage input signals 1045 and output signals 1050 for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. In other cases, the I/O controller 1010 may represent or interact with a modem, a keyboard, a mouse, a touchscreen, or a similar device. In some cases, the I/O controller 1010 may be implemented as part of a processor 1030. In some examples, a user may interact with the device 1005 via the I/O controller 1010 or via hardware components controlled by the I/O controller 1010.

The database controller 1015 may manage data storage and processing in a database 1035. In some cases, a user may interact with the database controller 1015. In other cases, the database controller 1015 may operate automatically without user interaction. The database 1035 may be an example of a single database, a distributed database, multiple distributed databases, a data store, a data lake, or an emergency backup database.

Memory 1025 may include random-access memory (RAM) and read-only memory (ROM). The memory 1025 may store computer-readable, computer-executable software including instructions that, when executed, cause at least one processor 1030 to perform various functions described herein. In some cases, the memory 1025 may contain, among other things, a basic I/O system (BIOS) which may control basic hardware or software operation such as the interaction with peripheral components or devices. The memory 1025 may be an example of a single memory or multiple memories. For example, the device 1005 may include one or more memories 1025.

The processor 1030 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 1030 may be configured to operate a memory array using a memory controller. In other cases, a memory controller may be integrated into the processor 1030. The processor 1030 may be configured to execute computer-readable instructions stored in at least one memory 1025 to perform various functions (e.g., functions or tasks supporting multi-application SSO via device session establishment). The processor 1030 may be an example of a single processor or multiple processors. For example, the device 1005 may include one or more processors 1030.

The device-bound session token manager 1020 may support establishing sessions via an authorization server in accordance with examples as disclosed herein. For example, the device-bound session token manager 1020 may be configured to support performing, via the authorization server, a first authorization procedure to establish a first session between a user device and a first server of a first organization. The device-bound session token manager 1020 may be configured to support receiving, from the user device, a request to access a resource after establishing the first session. The device-bound session token manager 1020 may be configured to support transmitting, to the user device, an authentication challenge in response to the request. The device-bound session token manager 1020 may be configured to support receiving, from an authenticator application of the user device, a response to the authentication challenge including a token indicative of the first session established via the first authorization procedure. The device-bound session token manager 1020 may be configured to support establishing a second session between the user device and a second server based on receiving the response to the authentication challenge, where the second session is associated with the first session in accordance with the response to the authentication challenge including the token.

By including or configuring the device-bound session token manager 1020 in accordance with examples as described herein, the device 1005 may support techniques for improved security related to accessing resources of organization servers and improved user experience related to authorization procedures.

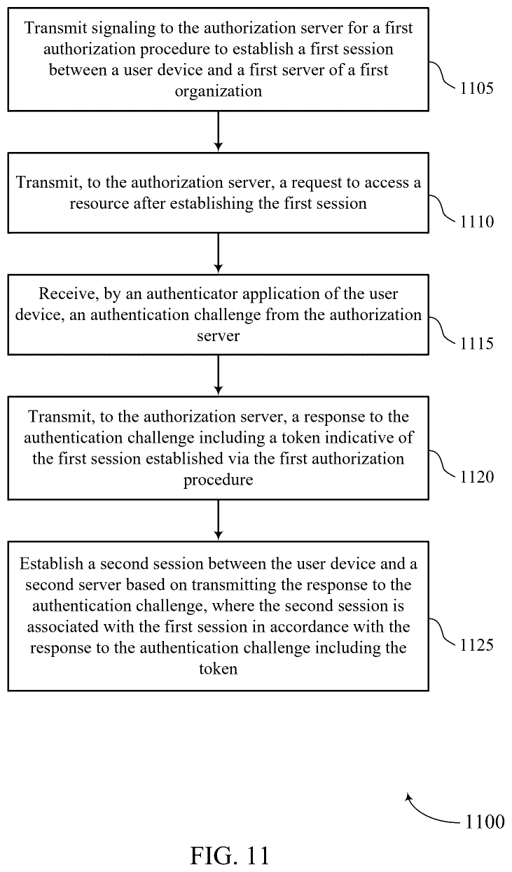

FIG. 11 shows a flowchart illustrating a method 1100 that supports multi-application SSO via device session establishment in accordance with aspects of the present disclosure. The operations of the method 1100 may be implemented by an Okta Device or its components as described herein. For example, the operations of the method 1100 may be performed by an Okta Device as described with reference to FIGS. 1 through 7. In some examples, an Okta Device may execute a set of instructions to control the functional elements of the Okta Device to perform the described functions. Additionally, or alternatively, the Okta Device may perform aspects of the described functions using special-purpose hardware.

At 1105, the method may include transmitting signaling to the authorization server for a first authorization procedure to establish a first session between a user device and a first server of a first organization. The operations of 1105 may be performed in accordance with examples as disclosed herein. In some examples, aspects of the operations of 1105 may be performed by an authorization procedure component 625 as described with reference to FIG. 6.

At 1110, the method may include transmitting, to the authorization server, a request to access a resource after establishing the first session. The operations of 1110 may be performed in accordance with examples as disclosed herein. In some examples, aspects of the operations of 1110 may be performed by an access request component 630 as described with reference to FIG. 6.

At 1115, the method may include receiving, by an authenticator application of the user device, an authentication challenge from the authorization server. The operations of 1115 may be performed in accordance with examples as disclosed herein. In some examples, aspects of the operations of 1115 may be performed by an authentication challenge component 635 as described with reference to FIG. 6.

At 1120, the method may include transmitting, to the authorization server, a response to the authentication challenge including a token indicative of the first session established via the first authorization procedure. The operations of 1120 may be performed in accordance with examples as disclosed herein. In some examples, aspects of the operations of 1120 may be performed by a response component 640 as described with reference to FIG. 6.

At 1125, the method may include establishing a second session between the user device and a second server based on transmitting the response to the authentication challenge, where the second session is associated with the first session in accordance with the response to the authentication challenge including the token. The operations of 1125 may be performed in accordance with examples as disclosed herein. In some examples, aspects of the operations of 1125 may be performed by a session establishment component 645 as described with reference to FIG. 6.

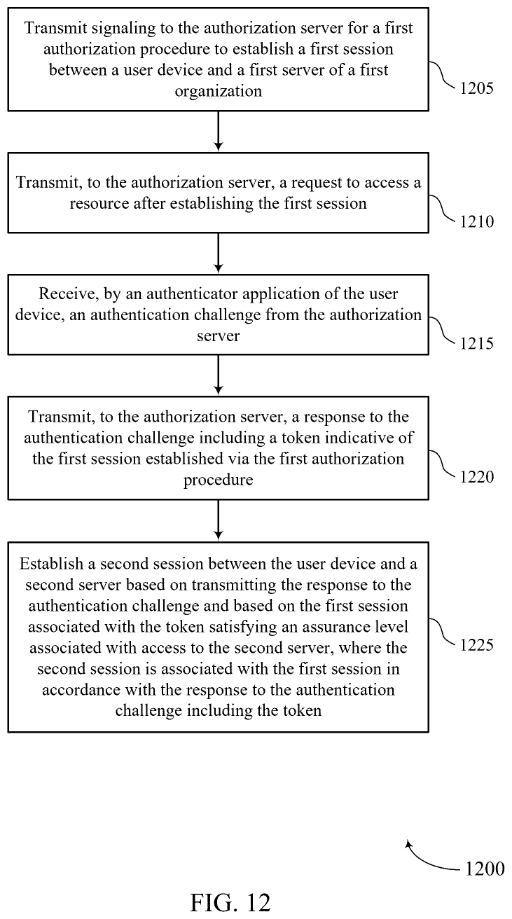

FIG. 12 shows a flowchart illustrating a method 1200 that supports multi-application SSO via device session establishment in accordance with aspects of the present disclosure. The operations of the method 1200 may be implemented by an Okta Device or its components as described herein. For example, the operations of the method 1200 may be performed by an Okta Device as described with reference to FIGS. 1 through 7. In some examples, an Okta Device may execute a set of instructions to control the functional elements of the Okta Device to perform the described functions. Additionally, or alternatively, the Okta Device may perform aspects of the described functions using special-purpose hardware.

At 1205, the method may include transmitting signaling to the authorization server for a first authorization procedure to establish a first session between a user device and a first server of a first organization. The operations of 1205 may be performed in accordance with examples as disclosed herein. In some examples, aspects of the operations of 1205 may be performed by an authorization procedure component 625 as described with reference to FIG. 6.

At 1210, the method may include transmitting, to the authorization server, a request to access a resource after establishing the first session. The operations of 1210 may be performed in accordance with examples as disclosed herein. In some examples, aspects of the operations of 1210 may be performed by an access request component 630 as described with reference to FIG. 6.

At 1215, the method may include receiving, by an authenticator application of the user device, an authentication challenge from the authorization server. The operations of 1215 may be performed in accordance with examples as disclosed herein. In some examples, aspects of the operations of 1215 may be performed by an authentication challenge component 635 as described with reference to FIG. 6.

At 1220, the method may include transmitting, to the authorization server, a response to the authentication challenge including a token indicative of the first session established via the first authorization procedure. The operations of 1220 may be performed in accordance with examples as disclosed herein. In some examples, aspects of the operations of 1220 may be performed by a response component 640 as described with reference to FIG. 6.

At 1225, the method may include establishing a second session between the user device and a second server based on transmitting the response to the authentication challenge including the token and based on the first session associated with the token satisfying an assurance level associated with access to the second server, where the second session is associated with the first session in accordance with the response to the authentication challenge including the token. The operations of 1225 may be performed in accordance with examples as disclosed herein. In some examples, aspects of the operations of 1225 may be performed by a session establishment component 645 as described with reference to FIG. 6.

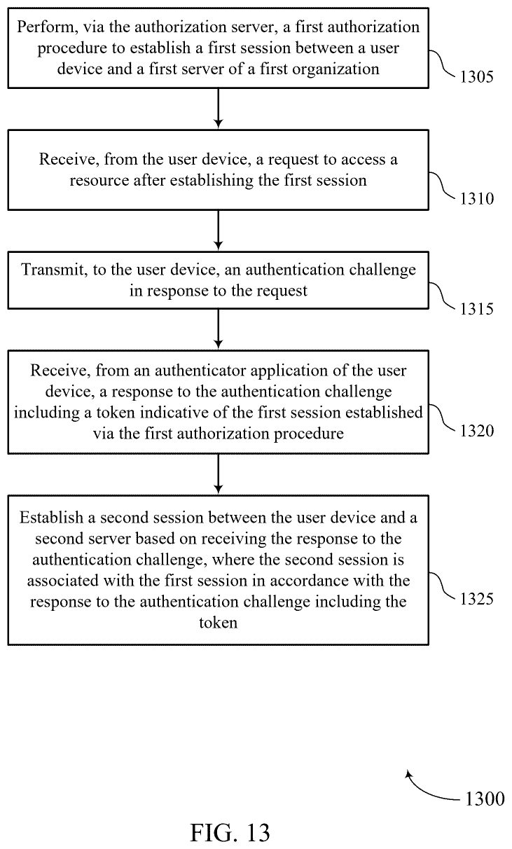

FIG. 13 shows a flowchart illustrating a method 1300 that supports multi-application SSO via device session establishment in accordance with aspects of the present disclosure. The operations of the method 1300 may be implemented by an Authorization Server or its components as described herein. For example, the operations of the method 1300 may be performed by an Authorization Server as described with reference to FIGS. 1 through 4 and 8 through 10. In some examples, an Authorization Server may execute a set of instructions to control the functional elements of the Authorization Server to perform the described functions. Additionally, or alternatively, the Authorization Server may perform aspects of the described functions using special-purpose hardware.

At 1305, the method may include performing, via the authorization server, a first authorization procedure to establish a first session between a user device and a first server of a first organization. The operations of 1305 may be performed in accordance with examples as disclosed herein. In some examples, aspects of the operations of 1305 may be performed by an authorization procedure manager 925 as described with reference to FIG. 9.

At 1310, the method may include receiving, from the user device, a request to access a resource after establishing the first session. The operations of 1310 may be performed in accordance with examples as disclosed herein. In some examples, aspects of the operations of 1310 may be performed by an access request manager 930 as described with reference to FIG. 9.

At 1315, the method may include transmitting, to the user device, an authentication challenge in response to the request. The operations of 1315 may be performed in accordance with examples as disclosed herein. In some examples, aspects of the operations of 1315 may be performed by an authentication challenge manager 935 as described with reference to FIG. 9.

At 1320, the method may include receiving, from an authenticator application of the user device, a response to the authentication challenge including a token indicative of the first session established via the first authorization procedure. The operations of 1320 may be performed in accordance with examples as disclosed herein. In some examples, aspects of the operations of 1320 may be performed by a response manager 940 as described with reference to FIG. 9.

At 1325, the method may include establishing a second session between the user device and a second server based on receiving the response to the authentication challenge, where the second session is associated with the first session in accordance with the response to the authentication challenge including the token. The operations of 1325 may be performed in accordance with examples as disclosed herein. In some examples, aspects of the operations of 1325 may be performed by a session establishment manager 945 as described with reference to FIG. 9.

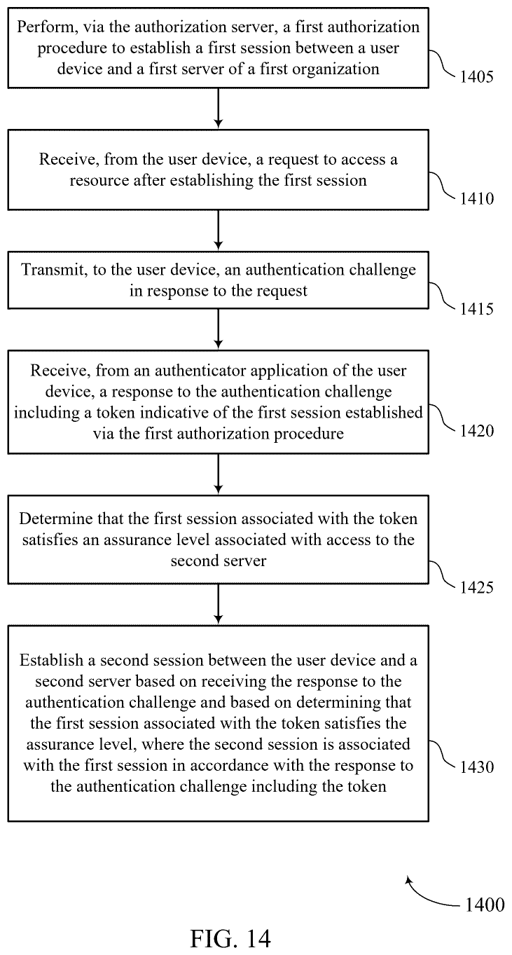

FIG. 14 shows a flowchart illustrating a method 1400 that supports multi-application SSO via device session establishment in accordance with aspects of the present disclosure. The operations of the method 1400 may be implemented by an Authorization Server or its components as described herein. For example, the operations of the method 1400 may be performed by an Authorization Server as described with reference to FIGS. 1 through 4 and 8 through 10. In some examples, an Authorization Server may execute a set of instructions to control the functional elements of the Authorization Server to perform the described functions. Additionally, or alternatively, the Authorization Server may perform aspects of the described functions using special-purpose hardware.

At 1405, the method may include performing, via the authorization server, a first authorization procedure to establish a first session between a user device and a first server of a first organization. The operations of 1405 may be performed in accordance with examples as disclosed herein. In some examples, aspects of the operations of 1405 may be performed by an authorization procedure manager 925 as described with reference to FIG. 9.

At 1410, the method may include receiving, from the user device, a request to access a resource after establishing the first session. The operations of 1410 may be performed in accordance with examples as disclosed herein. In some examples, aspects of the operations of 1410 may be performed by an access request manager 930 as described with reference to FIG. 9.

At 1415, the method may include transmitting, to the user device, an authentication challenge in response to the request. The operations of 1415 may be performed in accordance with examples as disclosed herein. In some examples, aspects of the operations of 1415 may be performed by an authentication challenge manager 935 as described with reference to FIG. 9.

At 1420, the method may include receiving, from an authenticator application of the user device, a response to the authentication challenge including a token indicative of the first session established via the first authorization procedure. The operations of 1420 may be performed in accordance with examples as disclosed herein. In some examples, aspects of the operations of 1420 may be performed by a response manager 940 as described with reference to FIG. 9.

At 1425, the method may include determining that the first session associated with the token satisfies an assurance level associated with access to the second server. The operations of 1425 may be performed in accordance with examples as disclosed herein. In some examples, aspects of the operations of 1425 may be performed by an assurance level manager 950 as described with reference to FIG. 9.

At 1430, the method may include establishing a second session between the user device and a second server based on receiving the response to the authentication challenge and based on determining that the first session associated with the token satisfies the assurance level, where the second session is associated with the first session in accordance with the response to the authentication challenge including the token. The operations of 1430 may be performed in accordance with examples as disclosed herein. In some examples, aspects of the operations of 1430 may be performed by a session establishment manager 945 as described with reference to FIG. 9.

The following provides an overview of aspects of the present disclosure:

Aspect 1: A method for establishing sessions via an authorization server, comprising: transmitting signaling to the authorization server for a first authorization procedure to establish a first session between a user device and a first server of a first organization; transmitting, to the authorization server, a request to access a resource after establishing the first session; receiving, by an authenticator application of the user device, an authentication challenge from the authorization server; transmitting, to the authorization server, a response to the authentication challenge comprising a token indicative of the first session established via the first authorization procedure; and establishing a second session between the user device and a second server based at least in part on transmitting the response to the authentication challenge, wherein the second session is associated with the first session in accordance with the response to the authentication challenge comprising the token.

Aspect 2: The method of aspect 1, wherein establishing the second session based at least in part on transmitting the response comprising the token further comprises: establishing the second session between the user device and the second server based at least in part on transmitting the response comprising the token and based at least in part on the first session associated with the token satisfying an assurance level associated with access to the second server.

Aspect 3: The method of aspect 1, further comprising: transmitting second signaling to the authorization server for a second authorization procedure to establish the second session between the user device and the second server, wherein transmitting the second signaling is based at least in part on the first session associated with the token failing to satisfy an assurance level associated with access to the second server; and establishing the second session between the user device and the second server based at least in part on transmitting the response to the authentication challenge comprising the token and the second authorization procedure, wherein a combination of the first authorization procedure associated with the first session and the second authorization procedure associated with the second session satisfy the assurance level.

Aspect 4: The method of any of aspects 1 through 3, wherein establishing the second session is based at least in part on the first session satisfying a policy associated with the second server, the policy indicating a time duration for which the token associated with the first session is usable to establish sessions with the second server.

Aspect 5: The method of any of aspects 1 through 4, wherein the first authorization procedure comprises a MFA procedure, the method further comprising: prompting, via a user interface of the authenticator application, a user of the user device to input information associated with at least two factors of a plurality of factors of the MFA procedure; and receiving, after prompting the user to input the information, one or more user inputs indicative of the at least two factors, wherein transmitting the signaling to the authorization server is based at least in part on receiving the one or more user inputs.

Aspect 6: The method of aspect 5, wherein the plurality of factors comprise a password, one or more security questions, SMS verification, voice verification, email verification, push verification via the authenticator application, possession of a cryptographic key, or any combination thereof.

Aspect 7: The method of any of aspects 1 through 6, wherein receiving the authentication challenge from the authorization server by the authenticator application comprises intercepting the authentication challenge transmitted from the authorization server to the user device.

Aspect 8: The method of any of aspects 1 through 7, wherein transmitting the signaling to the authorization server comprises: transmitting the signaling to the authorization server during or after a user login to the user device.

Aspect 9: The method of any of aspects 1 through 8, wherein the response to the authentication challenge further comprises an origin of the request, information associated with a security posture of the user device, a first attestation signed via a device-bound key, a second attestation signed via a user-bound key, or any combination thereof.

Aspect 10: The method of any of aspects 1 through 9, wherein the authenticator application is registered with the authorization server via a hardware-backed private key.

Aspect 11: The method of any of aspects 1 through 10, wherein the user device is associated with a user having a second private key.

Aspect 12: The method of any of aspects 1 through 11, wherein the first authorization procedure is in accordance with a MFA policy, a device posture policy, or both associated with the user device, the first organization, or both.

Aspect 13: A method for establishing sessions via an authorization server, comprising: performing, via the authorization server, a first authorization procedure to establish a first session between a user device and a first server of a first organization; receiving, from the user device, a request to access a resource after establishing the first session; transmitting, to the user device, an authentication challenge in response to the request; receiving, from an authenticator application of the user device, a response to the authentication challenge comprising a token indicative of the first session established via the first authorization procedure; and establishing a second session between the user device and a second server based at least in part on receiving the response to the authentication challenge, wherein the second session is associated with the first session in accordance with the response to the authentication challenge comprising the token.

Aspect 14: The method of aspect 13, further comprising: determining that the first session associated with the token satisfies an assurance level associated with access to the second server, wherein establishing the second session based at least in part on receiving the response comprising the token further comprises: establishing the second session between the user device and the second server based at least in part on determining that the first session associated with the token satisfies the assurance level.

Aspect 15: The method of any of aspect 13, further comprising: determining that the first session associated with the token fails to satisfy an assurance level associated with access to the second server; and performing, via the authorization server, a second authorization procedure to establish the second session between the user device and the second server based at least in part on determining that the first session associated with the token fails to satisfy the assurance level, wherein establishing the second session based at least in part on receiving the response comprising the token further comprises: establishing the second session between the user device and the second server based at least in part on receiving the response to the authentication challenge comprising the token and performing the second authorization procedure, wherein a combination of the first authorization procedure associated with the first session and the second authorization procedure associated with the second session satisfy the assurance level.

Aspect 16: The method of any of aspects 13 through 15, wherein establishing the second session is based at least in part on the first session satisfying a policy associated with the second server, the policy indicating a time duration for which the token associated with the first session is usable to establish sessions with the second server.

Aspect 17: The method of any of aspects 13 through 16, wherein the first authorization procedure comprises a MFA procedure, the method further comprising: receiving information indicative of at least two factors of a plurality of factors of the MFA procedure, wherein performing the first authorization procedure comprises verifying the at least two factors.

Aspect 18: The method of aspect 17, wherein the plurality of factors comprise a password, one or more security questions, SMS verification, voice verification, email verification, push verification via the authenticator application, possession of a cryptographic key, or any combination thereof.

Aspect 19: The method of any of aspects 13 through 18, wherein performing the first authorization procedure comprises: performing the first authorization procedure during or after a user login to the user device.

Aspect 20: The method of any of aspects 13 through 19, wherein the response to the authentication challenge further comprises an origin of the request, information associated with a security posture of the user device, a first attestation signed via a device-bound key, a second attestation signed via a user-bound key, or any combination thereof.

Aspect 21: The method of any of aspects 13 through 20, wherein the authenticator application is registered with the authorization server via a hardware-backed private key.

Aspect 22: The method of any of aspects 13 through 21, wherein the user device is associated with a user having a second private key.

Aspect 23: The method of any of aspects 13 through 22, wherein the first authorization procedure is in accordance with a MFA policy, a device posture policy, or both associated with the user device, the first organization, or both.

Aspect 24: An apparatus for establishing sessions via an authorization server, comprising one or more memories storing processor-executable code, and one or more processors coupled with the one or more memories and individually or collectively operable to execute the code to cause the apparatus to perform a method of any of aspects 1 through 12.

Aspect 25: An apparatus for establishing sessions via an authorization server, comprising at least one means for performing a method of any of aspects 1 through 12.

Aspect 26: A non-transitory computer-readable medium storing code for establishing sessions via an authorization server, the code comprising instructions executable by one or more processors to perform a method of any of aspects 1 through 12.

Aspect 27: An apparatus for establishing sessions via an authorization server, comprising one or more memories storing processor-executable code, and one or more processors coupled with the one or more memories and individually or collectively operable to execute the code to cause the apparatus to perform a method of any of aspects 13 through 23.

Aspect 28: An apparatus for establishing sessions via an authorization server, comprising at least one means for performing a method of any of aspects 13 through 23.

Aspect 29: A non-transitory computer-readable medium storing code for establishing sessions via an authorization server, the code comprising instructions executable by one or more processors to perform a method of any of aspects 13 through 23.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations, and does not represent all the examples that may be implemented, or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by one or more processors, firmware, or any combination thereof. If implemented in software executed by one or more processors, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for establishing sessions via an authorization server, comprising:
transmitting signaling to the authorization server for a first authorization procedure to establish a first session between a user device and a first server of a first organization;
transmitting, to the authorization server, a request to access a resource after establishing the first session;
receiving, by an authenticator application of the user device, an authentication challenge from the authorization server;
transmitting, to the authorization server, a response to the authentication challenge comprising a token indicative of the first session established via the first authorization procedure; and
establishing a second session between the user device and a second server based at least in part on transmitting the response to the authentication challenge, wherein the second session is associated with the first session in accordance with the response to the authentication challenge comprising the token.

2. The method of claim 1, wherein establishing the second session based at least in part on transmitting the response comprising the token further comprises:
establishing the second session between the user device and the second server based at least in part on transmitting the response comprising the token and based at least in part on the first session associated with the token satisfying an assurance level associated with access to the second server.

3. The method of claim 1, further comprising:
transmitting second signaling to the authorization server for a second authorization procedure to establish the second session between the user device and the second server, wherein transmitting the second signaling is based at least in part on the first session associated with the token failing to satisfy an assurance level associated with access to the second server; and
establishing the second session between the user device and the second server based at least in part on transmitting the response to the authentication challenge comprising the token and the second authorization procedure, wherein a combination of the first authorization procedure associated with the first session and the second authorization procedure associated with the second session satisfy the assurance level.

4. The method of claim 1, wherein establishing the second session is based at least in part on the first session satisfying a policy associated with the second server, the policy indicating a time duration for which the token associated with the first session is usable to establish sessions with the second server.

5. The method of claim 1, wherein the first authorization procedure comprises a multi-factor authentication (MFA) procedure, the method further comprising:
prompting, via a user interface of the authenticator application, a user of the user device to input information associated with at least two factors of a plurality of factors of the MFA procedure; and
receiving, after prompting the user to input the information, one or more user inputs indicative of the at least two factors, wherein transmitting the signaling to the authorization server is based at least in part on receiving the one or more user inputs.

6. The method of claim 5, wherein the plurality of factors comprise a password, one or more security questions, Short Message Service (SMS) verification, voice verification, email verification, push verification via the authenticator application, possession of a cryptographic key, or any combination thereof.

7. The method of claim 1, wherein receiving the authentication challenge from the authorization server by the authenticator application comprises intercepting the authentication challenge transmitted from the authorization server to the user device.

8. The method of claim 1, wherein transmitting the signaling to the authorization server comprises:
transmitting the signaling to the authorization server during or after a user login to the user device.

9. The method of claim 1, wherein the response to the authentication challenge further comprises an origin of the request, information associated with a security posture of the user device, a first attestation signed via a device-bound key, a second attestation signed via a user-bound key, or any combination thereof.

10. The method of claim 1, wherein the authenticator application is registered with the authorization server via a hardware-backed private key.

11. The method of claim 1, wherein the user device is associated with a user having a second private key.

12. The method of claim 1, wherein the first authorization procedure is in accordance with a multi-factor authentication (MFA) policy, a device posture policy, or both associated with the user device, the first organization, or both.

13. A method for establishing sessions via an authorization server, comprising:
performing, via the authorization server, a first authorization procedure to establish a first session between a user device and a first server of a first organization;
receiving, from the user device, a request to access a resource after establishing the first session;
transmitting, to the user device, an authentication challenge in response to the request;
receiving, from an authenticator application of the user device, a response to the authentication challenge comprising a token indicative of the first session established via the first authorization procedure; and
establishing a second session between the user device and a second server based at least in part on receiving the response to the authentication challenge, wherein the second session is associated with the first session in accordance with the response to the authentication challenge comprising the token.

14. The method of claim 13, further comprising:
determining that the first session associated with the token satisfies an assurance level associated with access to the second server, wherein establishing the second session based at least in part on receiving the response comprising the token further comprises:
establishing the second session between the user device and the second server based at least in part on determining that the first session associated with the token satisfies the assurance level.

15. The method of claim 13, further comprising:
determining that the first session associated with the token fails to satisfy an assurance level associated with access to the second server; and
performing, via the authorization server, a second authorization procedure to establish the second session between the user device and the second server based at least in part on determining that the first session associated with the token fails to satisfy the assurance level, wherein establishing the second session based at least in part on receiving the response comprising the token further comprises:
establishing the second session between the user device and the second server based at least in part on receiving the response to the authentication challenge comprising the token and performing the second authorization procedure, wherein a combination of the first authorization procedure associated with the first session and the second authorization procedure associated with the second session satisfy the assurance level.

16. The method of claim 13, wherein establishing the second session is based at least in part on the first session satisfying a policy associated with the second server, the policy indicating a time duration for which the token associated with the first session is usable to establish sessions with the second server.

17. The method of claim 13, wherein the first authorization procedure comprises a multi-factor authentication (MFA) procedure, the method further comprising:
receiving information indicative of at least two factors of a plurality of factors of the MFA procedure, wherein performing the first authorization procedure comprises verifying the at least two factors.

18. The method of claim 17, wherein the plurality of factors comprise a password, one or more security questions, Short Message Service (SMS) verification, voice verification, email verification, push verification via the authenticator application, possession of a cryptographic key, or any combination thereof.

19. The method of claim 13, wherein performing the first authorization procedure comprises:
performing the first authorization procedure during or after a user login to the user device.

20. An apparatus for establishing sessions via an authorization server, comprising:
one or more memories storing processor-executable code; and
one or more processors coupled with the one or more memories and individually or collectively operable to execute the code to cause the apparatus to:
transmit signaling to the authorization server for a first authorization procedure to establish a first session between a user device and a first server of a first organization;
transmit, to the authorization server, a request to access a resource after establishing the first session;
receive, by an authenticator application of the user device, an authentication challenge from the authorization server;
transmit, to the authorization server, a response to the authentication challenge comprising a token indicative of the first session established via the first authorization procedure; and
establish a second session between the user device and a second server based at least in part on transmitting the response to the authentication challenge, wherein the second session is associated with the first session in accordance with the response to the authentication challenge comprising the token.
